(19) United States
(12) Patent Application Publication
(10) Pub. No.: US 2025/0252374 A1
(43) Pub. Date: Aug. 7, 2025

(54) METHOD AND SYSTEM FOR SELECTING AND DEPLOYING UAVS

(71) Applicant: ECOLE DE TECHNOLOGIE SUPERIEURE, Montréal (CA)

(72) Inventors: Houssem Eddine MOHAMADI, Montréal (CA); Nadija KARA, Kirkland (CA); Mohand LAGHA, Blida (DZ)

(21) Appl. No.: 18/854,601

(22) PCT Filed: Apr. 5, 2023
(86) PCT No.: PCT/CA2023/050461

§ 371 Date: Oct. 7, 2024

Related U.S. Application Data
(60) Provisional application No. 63/327,446, filed on Apr. 5, 2022.

(51) Int. Cl. G06Q 10/0631; B64U 101/21; B64U 101/31; G08G 5/27

(52) U.S. Cl. CPC G06Q 10/06315; G08G 5/27; B64U 2101/21; B64U 2101/31

(57) ABSTRACT

A method and a system for selecting and deploying one of unmanned aerial vehicles (UAVs) and microservices or Functions-as-a-Service (FaaS) comprise selecting a preliminary number of UAVs, microservices or FaaS for deployment by defining possible outcomes for criteria having predefined constraints and associated priority weights, computing a penalty factor score (SPF) based on whether or not each possible outcome violates the constraints, computing a compactness factor score (SCF) based on how close or far the possible outcomes are from an average score of all values falling under a same type of criteria, ranking the possible outcomes using SPF and SCF, and selecting the preliminary number based on the ranking. Positions of the preliminary number of UAVs within the area of interest are determined to maximize coverage and minimize overlap. A placement of the preliminary number of microservices or FaaS is determined to minimized a targeted deployment cost.

### CROSS-REFERENCE TO RELATED APPLICATIONS

The present application claims priority from U.S. Patent Application No. 63/327,446, filed on Apr. 5, 2022, the entire contents of which are incorporated herein by reference.

### TECHNICAL FIELD

The present disclosure relates to a deployment method and system. More particularly, the present disclosure relates to a deployment method and system according to a group of requirements.

### BACKGROUND

Unmanned Aerial Vehicles (UAVs) or drones are increasingly being used in numerous military and civil expeditions such as expeditions that could be dull, dirty or dangerous (often labeled as the “three Ds”). To execute a specific set of tasks, the UAV can either be controlled by a preprogrammed onboard computer or by a remotely located computer or human. UAVs are foreseen as a key component of Internet of Things (IoT) infrastructure, as they can be seamlessly integrated in various advanced architectures since they are dynamic, highly autonomous, deployable, versatile, and controllable with ease.

Hence, by leveraging IoT concepts, UAVs can deliver IoT services from various levels of altitude. These services may include for instance: improved search and rescue missions, environmental inspection and wildlife monitoring when combined with computer vision and infrared thermography; smart farming and agriculture by gathering data from a set of sensors deployed in the field or crop spraying and monitoring; real-time fire suppression in smart forest management when equipped with infrared sensors or by collecting data from flame detectors deployed in forests prone to fires.

Another scenario pertains to setting up UAVs as relays or aerial base stations and building Aeronautical Ad-hoc Networks (AANETs) to deliver telecommunication services to users. Aerial base stations can possess a higher probability of line-of-sight (LoS) links towards other base stations and users. Indeed, UAVs are able to attain a better coverage and performance rate of wireless networks in various use cases including but not limited to emergencies and temporary hotspots in addition to providing fast, reliable and cost-effective on-demand communications and network access to non-covered or poorly covered regions.

Unlike terrestrial base stations, UAVs are deployed in the air at flexible and adjustable locations. Due to their aeronautical features and flying nature, they can operate with different velocities and altitudes depending on cellular traffic and cellular data and are able to ensure a ubiquitous cellular coverage with relative ease.

However, determining the suitable number of UAVs that are necessary to deploy in order to provide a desired coverage level is still a challenge. In addition, determining the appropriate 3D position (i.e., latitude, longitude, and elevation) for each UAV in order to provide a satisfactory coverage level is also a challenge. Each application has a set of attributes that must be considered in order to determine the adequate number of UAVs that should be deployed and to determine their 3D position.

Therefore, there is a need for improvement.

### SUMMARY

According to one aspect, a multi-objective decision-making (MCDM) and constraints-handling method (herein referred as the “SAGA method”) is applied to solve real world MCDM selection problems, such as to determine the number of UAVs, microservices or Functions-as-a-Service (FaaS) to deploy (e.g., to adequately cover a predetermined area).

According to one embodiment, the SAGA method involves generating a decision matrix according to a group of UAVs deployment requirements, evaluating candidate options according to a penalty factor and a compactness factor and further determining a number of UAVs to deploy according to the candidate options and a desired level of coverage accuracy or an acceptable level of coverage.

According to one embodiment, the decision matrix is generated according to an area of interest. The decision matrix is generated by dividing the area of interest into subareas that have a predetermined geometric shape, such as square, circular, and triangular shapes or any other predetermined shape or combination of shapes be it regular or irregular shapes.

According to another aspect there is provided herein a method of determining a positioning of a group of UAVs to achieve an adequate coverage of an area of interest, by limiting overlapping of UAV covered zones and limit extending over an outside perimeter of the area of interest.

According to one embodiment, the method involves obtaining the number of UAVs, setting an altitude upper limit according to the UAVs and number of UAVs to deploy. Then, randomly positioning the UAVs and evaluating UAV candidate positions according to at least one fitness term. Then further establishing a selection likelihood of each UAV candidate position and sorting the UAV candidate positions. The method further includes, selecting the UAV candidate positions according to the sorting and then determining an appropriate positioning of each UAV.

According to yet another aspect, there is provided a method of calculating orientation parameters for each UAV to deploy.

According to one embodiment, the method involves generating a grid-map of an area of interest, then identifying all uncovered grid points of the grid map, generating sub-maps, selecting UAV orientation parameters, and computing associated azimuth angles. The selecting UAV orientation parameters is performed according to the uncovered grid points and according to non-overlapping coverage zones associated to each UAV and also according to orientation parameters of other UAVs and coverage levels of all UAVs. The method further includes iteratively calculating orientation parameters of each UAV or each UAV mounted devices, such as a camera, sensing device, transceiving device, etc. Possible orientation parameters include tilt angle, coverage radii or slant ranges, pitch, yaw etc.

In some embodiments, the UAVs are deployed based on the number of UAVs selected and the positions and orientations as determined using the methods described herein.

In accordance with one aspect, there is provided a method for selecting and deploying one of a set of unmanned aerial vehicles (UAVs) over a geographical area of interest and a set of microservices or Functions-as-a-Service (FaaS) over a distributed communication environment. The method comprises selecting a preliminary number of UAVs, microservices or FaaS for deployment by defining possible outcomes for a plurality of criteria having predefined constraints and associated priority weights, computing a penalty factor score (SPF) based on whether or not each one of the possible outcomes violates the predefined constraints, computing a compactness factor score (SCF) based on how close or far the possible outcomes are from an average score of all values falling under a same type of criteria, determining a ranking of the possible outcomes using SPF and SCF, and selecting the preliminary number of UAVs, microservices or FaaS based on the ranking. The method also comprises one of determining positions of the preliminary number of UAVs within the area of interest to maximize coverage of the area of interest and minimize overlap between the preliminary number of UAVs and determining orientations of the preliminary number of UAVs within the area of interest for the positions as determined, and determining a placement of the preliminary number of microservices or FaaS over the distributed communication environment to minimize a targeted deployment cost.

In some embodiments, the method further comprises reassessing the preliminary number of UAVs for deployment as a function of the positions and orientations as determined or reassessing the preliminary number of microservices or FaaS for deployment as a function of the placement as determined.

In some embodiments, the method further comprises synchronizing a rotation of the UAVs based on the positions and orientations of the preliminary number of UAVs.

In some embodiments, selecting the preliminary number of UAVs, microservices or FaaS further comprises computing a distance factor score (SDF) by measuring a distance between the possible outcomes for the plurality of criteria and the corresponding constraints for the criteria, and ranking the possible outcomes comprises ranking using SPF, SCF and SDF.

In some embodiments, the geographical area of interest is modeled as one of circular, rectangular, triangular, and square shaped areas.

In some embodiments, the geographical area of interest is divided into sub-areas.

In some embodiments, the predefined constraints are defined using linguistic quantifiers and logic operators.

In some embodiments, textual terms are converted into the linguistic quantifiers using machine learning.

In some embodiments, a parameter is used to differentiate between beneficial criteria and cost criteria, where the parameter is 1 for the beneficial criteria and 0 for the cost criteria, and the possible outcomes that violate the predefined constraints are retained for the ranking.

In some embodiments, the method further comprises deploying the UAVs with the positions and orientations as determined or deploying the microservices or FaaS with the placement as determined.

In accordance with another aspect, there is provided a system for selecting and deploying one of a set of unmanned aerial vehicles (UAVs) over a geographical area of interest and a set of microservices or Functions-as-a-Service (FaaS) over a distributed communication environment. The system comprises a processor and a non-transitory computer readable medium having stored thereon program instructions executable by the processor for selecting a preliminary number of UAVs, microservices or FaaS for deployment by defining possible outcomes for a plurality of criteria having predefined constraints and associated priority weights, computing a penalty factor score (SPF) based on whether or not each one of the possible outcomes violates the predefined constraints, computing a compactness factor score (SCF) based on how close or far the possible outcomes are from an average score of all values falling under a same type of criteria, determining a ranking of the possible outcomes using SPF and SCF, and selecting the preliminary number of UAVs, microservices or FaaS based on the ranking. The program instructions are further executable by the processor for one of determining positions of the preliminary number of UAVs within the area of interest to maximize coverage of the area of interest and minimize overlap between the preliminary number of UAVs and determining orientations of the preliminary number of UAVs within the area of interest for the positions as determined, and determining a placement of the preliminary number of microservices or FaaS over the distributed communication environment to minimize a targeted deployment cost.

In some embodiments, the program instructions are further executable for reassessing the preliminary number of UAVs for deployment as a function of the positions and orientations as determined or reassessing the preliminary number of microservices or FaaS for deployment as a function of the placement as determined.

In some embodiments, the program instructions are further executable for synchronizing a rotation of the UAVs based on the positions and orientations of the preliminary number of UAVs.

In some embodiments, selecting the preliminary number of UAVs, microservices or FaaS further comprises computing a distance factor score (SDF) by measuring a distance between the possible outcomes for the plurality of criteria and the corresponding constraints for the criteria, and ranking the possible outcomes comprises ranking using SPF, SCF and SDF.

In some embodiments, the geographical area of interest is modeled as one of circular, rectangular, triangular, and square shaped areas.

In some embodiments, the geographical area of interest is divided into sub-areas.

In some embodiments, the predefined constraints are defined using linguistic quantifiers and logic operators.

In some embodiments, textual terms are converted into the linguistic quantifiers using machine learning.

In some embodiments, a parameter is used to differentiate between beneficial criteria and cost criteria, where the parameter is 1 for the beneficial criteria and 0 for the cost criteria, and the possible outcomes that violate the predefined constraints are retained for the ranking.

In some embodiments, the program instructions are further executable for deploying the UAVs with the positions and orientations as determined or deploying the microservices or FaaS wih the placement as determined.

### BRIEF DESCRIPTION OF THE DRAWINGS

Further features and advantages of the present method and system will become apparent from the following detailed description, taken in combination with the appended drawings, in which:

FIGS. 1A to 1E present a variety of geographical areas that are serviced by a group of drones or Unmanned Aerial Vehicles (UAVs), according to one embodiment;

FIG. 2 presents a method of planning the deployment of UAVs, according to one embodiment;

FIG. 3A presents a method of determining a preliminary number of UAVs to deploy for planning the deployment of UAVs according to the method of FIG. 2, according to one embodiment;

FIG. 3B presents a method of evaluating candidate options for determining a preliminary number of UAVs to deploy according to the method of FIG. 3A, according to one embodiment;

FIG. 3C presents an example algorithm for finding a distance factor DF for determining a preliminary number of UAVs to deploy;

FIG. 4A presents a method of establishing a positioning of the preliminary number of UAVs to deploy for planning the deployment of UAVs according to the method of FIG. 2, according to one embodiment;

FIG. 4B presents a method of selecting candidate UAV positions for establishing the positioning according to the method of FIG. 4A, according to one embodiment;

FIG. 5 presents a graph identifying a group of possible UAV position solutions according to fitness functions f1 and f2 with respect to a Pareto front, according to one embodiment;

FIG. 6A presents a method of determining UAV orientation parameters for planning the deployment of UAVs according to the method of FIG. 2, according to one embodiment;

FIG. 6B presents a method of generating sub-maps for determining UAV orientation parameters of the method of FIG. 6A;

FIG. 6C presents a method of selecting UAV orientation parameters from candidate orientation parameters for determining UAV orientation parameters of the method of FIG. 6A, according to one embodiment;

FIG. 6D presents a method of determining UAV orientation parameters for planning the deployment of UAVs according to the method of FIG. 2, according to yet another one embodiment;

FIG. 7A presents a decision matrix, according to one embodiment;

FIG. 7B presents a decision matrix, according to another embodiment;

FIG. 8 presents table describing a coverage level depending on a shape of an area of interest and a number of deployed UAVs, according to a prior art coverage level determination method;

FIG. 9A presents a source code for performing a method to evaluate candidate options according to a decision matrix for determining a number of UAVs to deploy according to the method of FIG. 2, according to one embodiment;

FIG. 9B presents a method to evaluate candidate options according to a decision matrix for determining a number of UAVs to deploy according to the method of FIG. 2, according to one embodiment;

FIG. 10A presents a method of selecting candidate UAV positions for establishing a positioning of the preliminary number of UAVs to deploy of the method of FIG. 4A, according to one embodiment;

FIG. 10B presents an area of interest being covered by three UAVs, the three UAVs providing a coverage having coverage zones, overlapping coverage zones and non-covered zones, according to one embodiment;

FIG. 10C presents a method of planning the deployment of UAVs, according to one embodiment;

FIG. 11A presents a grid-map of an area of interest, the grid-map is divided into sub-maps which are sub-divided into sections, according to one embodiment;

FIG. 11B presents two sub-maps each associated to a UAV, the UAV having orientation parameters that are controllable to provide coverage of each associated section, according to one embodiment;

FIG. 12A presents a source code for identifying candidate UAV orientation parameters according to the method of FIG. 6C, according to one embodiment;

FIG. 12B presents a collection matrix of various candidate UAV orientation parameters for selecting UAV orientation parameters according to the method of FIG. 6C, according to one embodiment;

FIG. 13A presents a source code for selecting UAV orientation parameters from candidate UAV orientation parameters according to the method of FIG. 6C, according to one embodiment;

FIG. 13B presents a confirmed matrix of selected UAV orientation parameters according to the method of FIG. 6C, according to one embodiment;

FIG. 14 presents a triangular shaped are of interest being covered by two UAVs each being controllable according to the selected orientation parameters of the method of FIG. 6A, according to one embodiment;

FIG. 15 presents a UAV deployment planning system, according to one embodiment;

FIG. 16 presents a source code for synchronizing rotation of UAVs according to one embodiment;

FIGS. 17A-17B show a first example scenario for rotation of UAVs;

FIGS. 18A-18B show a second example scenario for rotation of UAVs;

FIG. 19 illustrates different deployment infrastructures of microservices-based or FaaS-based applications, according to one embodiment;

FIG. 20 presents a method of planning the deployment of microservices and/or FaaS, according to one embodiment; and

FIG. 21 presents a method of determining a preliminary number of microservices and/or to deploy for planning the deployment of microservices and/or according to the method of FIG. 20, according to one embodiment.

It will be noted that throughout the appended drawings, like features are identified by like reference numerals.

### DETAILED DESCRIPTION

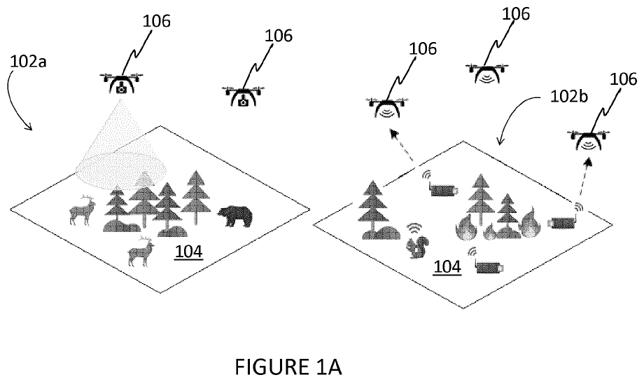

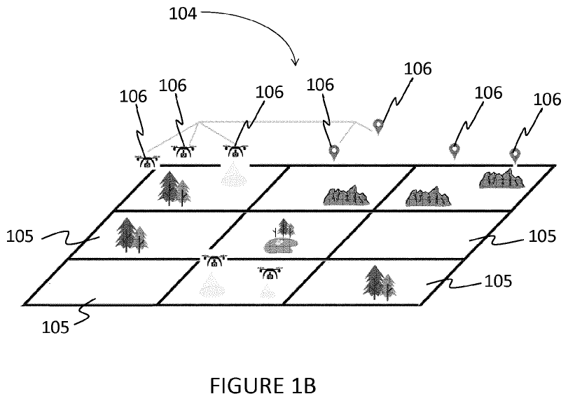

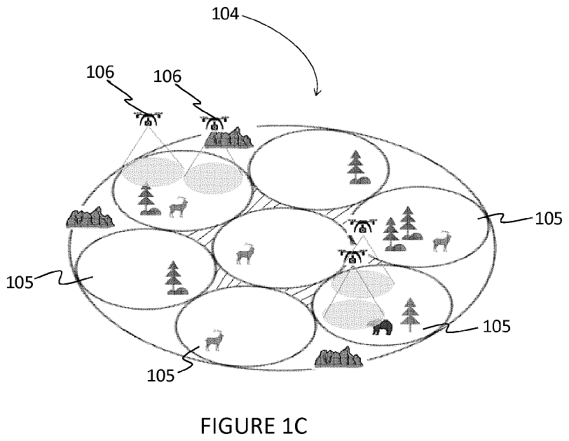

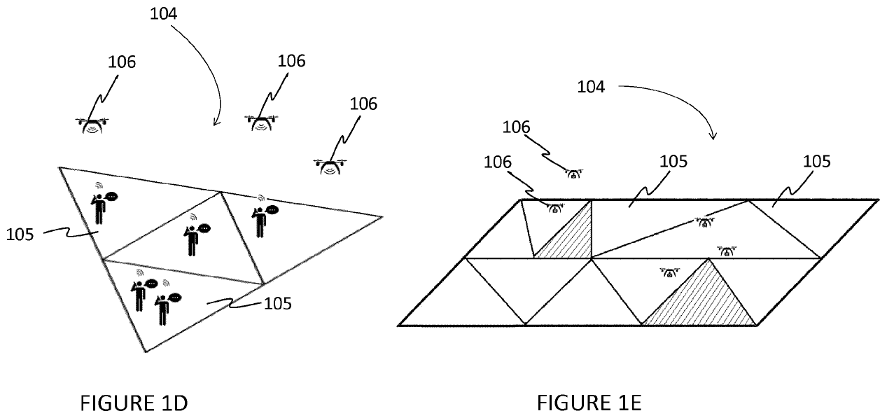

In one embodiment, the present disclosure is directed to methods and systems for selecting a suitable set of UAVs equipped with IoT devices or proper surveillance systems, and to deploy them across a given geographical area of interest for a specific coverage task. This may be done, for example, for wildlife monitoring or forestry data collection. Presented in FIG. 1A is a wildlife monitoring system 102a and a forestry data collection system 102b adapted to respectively monitor and collect information from a same given geographical area or area of interest 104 for a specific coverage task. The systems (102a and 102b) have an adequate number of UAVs 106 assisted with proper equipment add-ons, depending on the specific coverage task. For instance, the system 102a has UAVs 106 that are equipped with infrared cameras or rotating video cameras for capturing images and the system 102b has UAVs 106 that are equipped with receivers for collecting data from sensors located at ground level.

According to one embodiment, the systems 102a or 102b are customizable and can be used in a variety of applications; in fact, the systems 102a and 102b are application-agnostic. For instance, the forestry data collection system 102b can be re-customized to function as a radio network. In this case, the UAVs 106 are configured as mobile base stations and an air-to-ground transmission model is applied. For this purpose, application specific criteria are considered during the UAVs selection process. For instance, the operational altitude of UAVs and various communication issues (such as RSS index, SINR, PLOS/NLOS, attenuation, interference, radiation patterns) are inherently taken into consideration to adequately determine the position of each UAV 106.

According to one embodiment, the coverage provided by the UAVs 106 is modeled using a multiple circles packing/placement technique in order to obtain a desired level of coverage. The geographical area or area of interest 104 may be of various geometric shapes. For instance, as presented in FIGS. 1B, 1C, 1D and 1E, the technique is modeled to deploy UAVs above circular, rectangular and/or triangular shaped areas of interest 104. Each area of interest 104 can be divided into sub-areas 105 of a variety of shapes such as circular, rectangular and triangular. The sub-areas 105 have a given radius or side length and is associable to a single UAV.

According to one embodiment as presented in FIG. 1B, there is an area of interest 104 having a square shape that is divided into rectangular shaped sub-areas 105. In another case as shown in FIG. 1C, the area of interest 104 has a circular shape that is divided into circular shaped sub-areas 105. In yet another case, as shown in FIG. 1D, the area of interest 104 has a triangular shape that is divided into triangular shaped sub-areas 105. Combinations of area shapes and sub-area shapes are also possible, such as presented in FIG. 1E, where the area of interest 104 is rectangular shaped and the sub-areas 105 are defined by a variety of triangular shapes.

The area of interest 104 can also have any other type of regular or irregular shape. Moreover, the area of interest 104 can be divided into sub-areas 105 having any type of shapes or combination of different shapes, be it regular or irregular shapes.

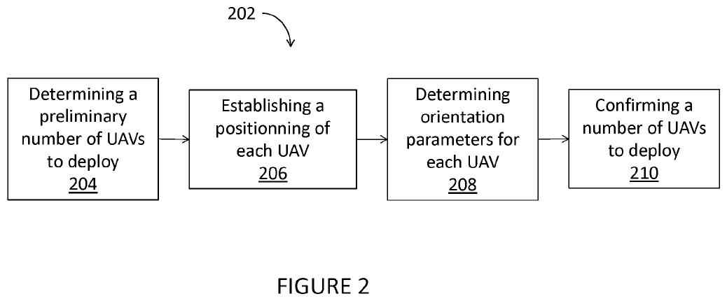

According to one embodiment, as presented in FIG. 2, there is a method 202 of planning UAVs 106 deployment. The method 202 includes determining a preliminary number of UAVs to be deployed 204, establishing a positioning of each UAV 206, calculating orientation parameters for each UAV 208 and confirming the number of UAVs to deploy 210.

### Determining Preliminary Number of UAVs

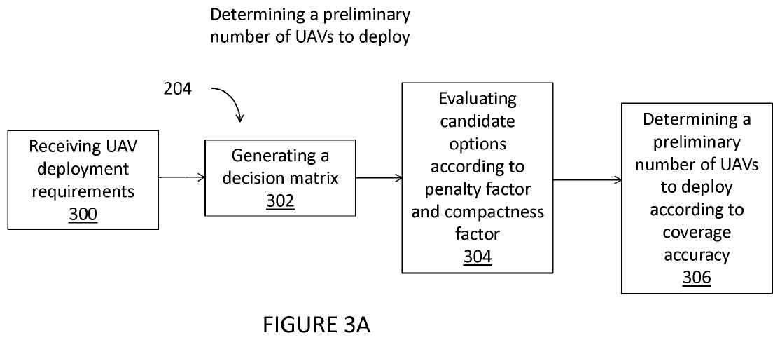

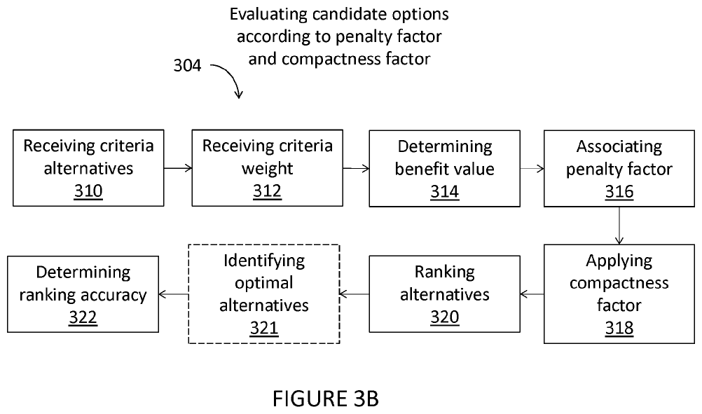

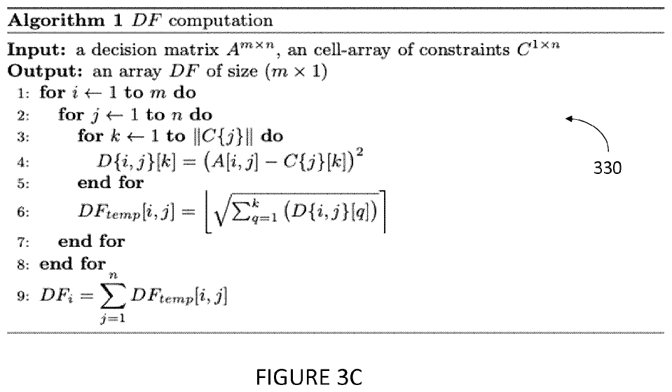

According to one embodiment, as presented in FIG. 3A, the determining a preliminary number of UAVs to be deployed 204 includes receiving UAV deployment requirements or criteria 300, generating a decision matrix 302, evaluating candidate options 304 and determining a preliminary number of UAVs to deploy 306. The received deployment requirements 300 include a variety of requirements that are application specific (coverage level thresholds, type of information to capture or transceiver, etc.), UAV specific (i.e., UAV autonomy, flight altitude criteria, coverage capacity, UAV cost etc.) and also specific to the area of interest (size, shape, sub-area size, sub-area shape, etc.). According to the received deployment requirements, the decision matrix 302 is generated in order to determine an adequate preliminary number of UAVs that are to be deployed and to satisfy a desired coverage level. Notice that the variety of deployment requirements received 300 are in many cases inconsistent requirements. For instance, the desired coverage level can be established according to a variety of inconsistent predetermined requirements such as Quality-of-Service (QOS) requirements and other user requirements (e.g., good spatial resolution or high Line-of-Sight (LoS) coverage probability, long hovering duration, minimum purchase cost, etc.).

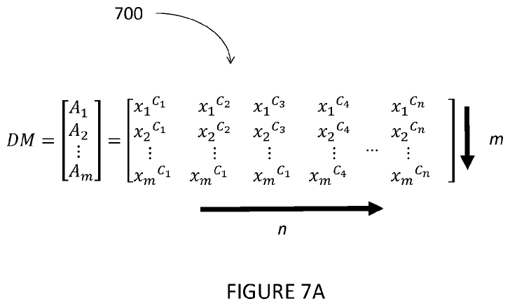

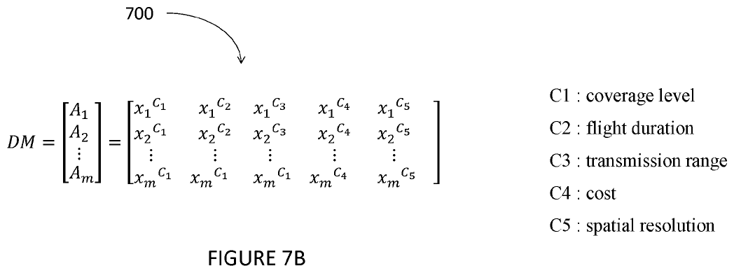

According to one embodiment as further presented in FIG. 3A and concurrently presented in FIG. 7A, the decision matrix is generated 302 according to a group of quantitative UAV specific criteria, identified as (xᵢ^{c}^{ᵢ}) in decision matrix 700. For instance, the group of UAV specific criteria (xᵢ^{c}^{ᵢ}) can include Coverage level criteria, Endurance, Transmission range, UAV price and Spatial resolution. However, it shall be recognized that the type and number of UAV specific criteria (xᵢ^{c}^{ᵢ}) can differ depending on the application and requirements.

According to one embodiment, the decision matrix is generated 302 according to a group of quantitative UAV specific requirements and also according to area of interest specific requirements such as the borders of an area of interest 104 and the borders of each sub-area 105.

It shall be recognized that the UAV specific requirements can for instance be indicative of a set of different types of UAVs each having their own built-in specifications such as size, weight and power (SWAP), flying speed, battery independence, etc. The decision matrix can also be represented by possible outcomes (Ai) that are associated to a group of requirements xᵢ^{c}^{ᵢ}) be it UAV specific requirements and/or area of interest specific requirements in order to evaluate potential candidate options.

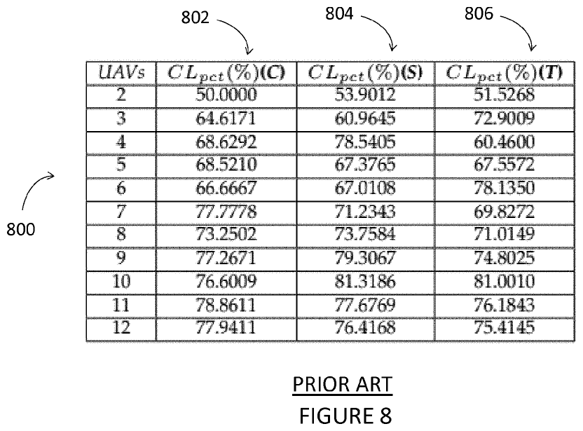

According to one embodiment, a Coverage level criterion is referred to as “C1” in the matrix 700. An efficient deployment scheme is applied for a group of UAVs based on a circle packing theory and an exact extra gap areas approach. The coverage level in this case is equivalent to the density of packing at least two (2) non-overlapping circles—the circles being indicative of coverage zones respectively associated to each UAV—within an area of interest 104. For instance, table 800 of FIG. 8 is taken from Gaspar z. and Tarnai T. (2000), Upper bound of density for packing of equal circles in special domains in the plane, 44 (1), 13-32, and provides a coverage level determined according to a Prior art coverage determination method. As can be noticed, the coverage levels depend on the number of UAVs and the shape of the area of interest whether it is a circular (C) 802, square(S) 804 or triangular (T) 806.

According to one embodiment, since it is not desirable to leave certain areas non-covered or barely covered while covering other areas for a longer period of time and it is not always possible to have sufficient UAVs to cover a large area for a prolonged period of time, the area of interest 104 is divided into sub-areas 105 each having either a circle, square of triangular shape. To ensure that each sub-area 105 is covered for an adequate amount of time, the UAVs are grouped in swarms to sweep each sub-area 105 in a consistent manner. For simplicity, as presented in FIG. 1B, a large area of interest 104 is split into square shaped sub-areas 105, each sub-area 105 having a substantially same size. Hence, the continuous coverage of a whole area of interest is expressed as the following:

$$AoI coverage = \frac{Number of UAVs groups}{Total number of sub - areas} {CL}_{pct} \qquad ( 1 )$$

Endurance is referred to as “C2” in the matrix 700. In order to prolong the coverage period-since UAVs cannot keep flying or hovering for a long period of time due to their limited energy supply-UAVs need to be maneuvered in an energy efficient manner.

Transmission range is referred to as “C3” in the matrix 700. The UAVs must maintain an adequate connection with other UAVs of the swarm at all times for an accurate performance. Accordingly, the distance that allows UAVs to communicate with each other is indicative of the transmission range. According to one embodiment, the distance between each neighboring UAV must be within twice the coverage radius of the UAV. Notice that the method assumes that all UAVs are adapted to provide a same coverage radius.

UAV price is referred to as “C4” in the matrix 700. Financial aspects may also be considered since increasing the number of UAVs may lead to more expenditures.

Spatial resolution is referred to as “C5” in the matrix 700 (see FIG. 1B). Spatial resolution is the depth limit beyond which a target at ground level can no longer be satisfactorily detected. A very high spatial resolution of UAV imagery may cause some challenges since the images can capture for instance, undesirable information about ground features (e.g., shadow) adding image noise.

A skilled person will recognize that the number of criteria or the criteria types may differ depending on the application and the type of UAV and an unlimited number of criteria can be defined in the decision matrix 700.

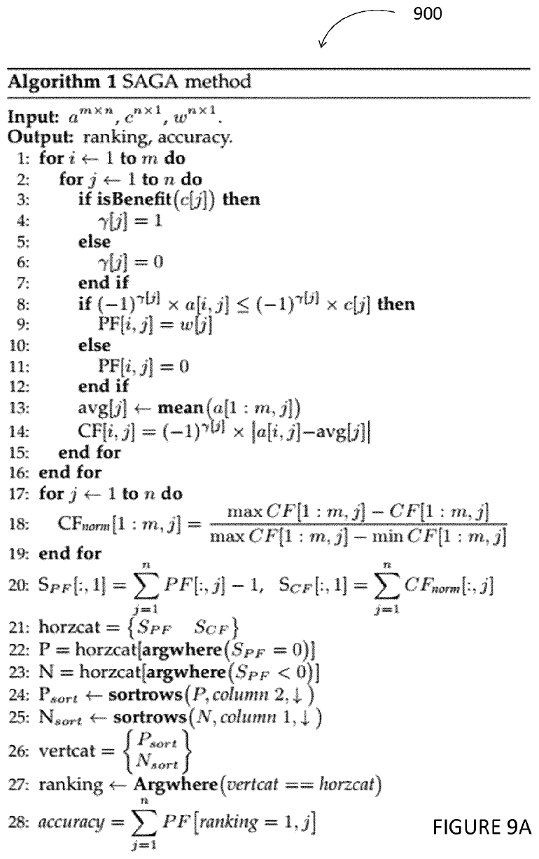

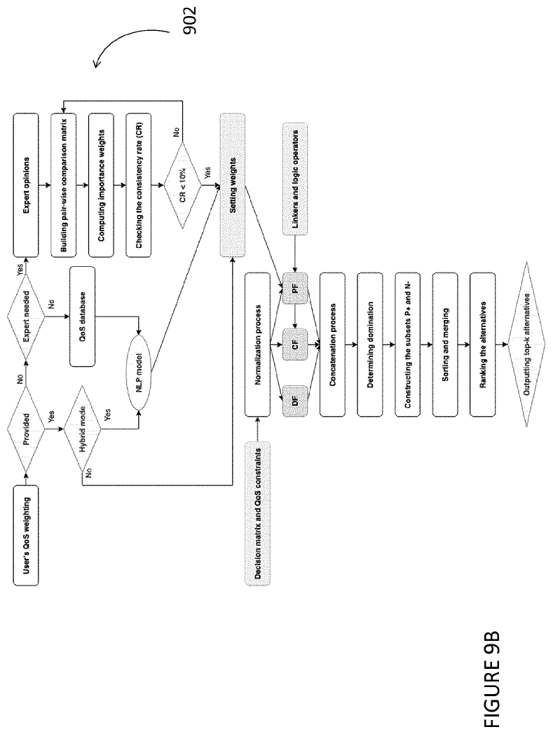

According to one embodiment, the candidate options are evaluated 304 according to a Satisficing Additive-weights and Goal Attributed ranking method (SAGA) as presented in algorithm 900 of FIG. 9A. The evaluation method 304 is a multi-objective decision-making and criteria-handling method for Multi-Criteria Decision-Making MCDM selection problems. According to one embodiment, the evaluation method 304 or SAGA algorithm 900 maintains and evaluates all possible outcomes including unsatisfactory possible outcomes—that is possible outcomes that violate at least one criterion—since the method 304 assumes that unsatisfactory possible outcomes may be of relevance in the selection process. Moreover, the evaluation method 304 combines different sets of preference priorities and quantifiable objectives that can be considered when selecting a solution, be it an optimal solution or a less optimal solution that still offers adequately fitting conditions.

According to one embodiment, the candidate options are evaluated according to the evaluation method 304 presented in FIG. 3B and the SAGA algorithm 900 presented in FIG. 9A. The evaluation method 304 includes receiving criteria possible outcomes (referred to as “alternatives” in FIG. 3B) 310 and receiving criteria weights 312. Then determining a benefit value for each criteria possible outcome 314 and associating a penalty factor 316 to each criteria possible outcome according to the respective benefit value and corresponding criteria weights. Then applying a compactness factor 318 to each criteria possible outcome according to the benefit value and a criteria dispersion indicator. Then ranking the possible outcomes 320 according to the applied compactness factor and associated penalty factor, and further optionally identifying optimal possible outcomes or optimal options according to the ranking 321. Then determining an accuracy indicator 322 for each of the identified optimal possible outcomes or for each of the ranked possible outcomes according to the penalty factor.

As detailed by the algorithm 900 and evaluation method 304, respectively presented in FIGS. 9A and 3B, the SAGA method 304 takes as input an m×n decision matrix (a^{m×n}) 310, such as decision matrix 700, where m is the number of possible outcomes and n the number of criteria. Moreover, the SAGA method 304 takes as input an n×1 array of criteria (c^{n×1}) and an n×1 array of importance weights (w^{n×1}) 312. The SAGA method 304 is configured to output a ranking indicator 320 for each option or possibility and an accuracy indicator 322 for options that are identified as optimal or so far optimal. It shall be recognized that the accuracy indicator can also be associated to each possibility and not only the ones that are identified as optimal, without departing from the spirit of the present solution.

As further presented in the algorithm 900 and the method 304, a parameter γ is used to evaluate the possible outcomes and is indicative of a respect of criteria, which are beneficial, or non-beneficial 314. For instance, for each instance of the m×n possible outcomes of a group of criteria, there is associated either a beneficial value (γ=1) or non-beneficial value (γ=0). In addition, a penalty factor is determined according to a criteria priority weight or the n×1 array of importance weights, depending on the level of importance of each criterion. The algorithm 900 applies the penalty factor 316 to each m×n possible outcome's criteria in accordance with the n×1 importance weight array. For instance, the penalty factor (PF) can be applied in such a way that when a possible outcome's criteria meet a given condition, such as the condition indicated in line 8 of the algorithm 900, the assessment outcome is influenced by the associated importance or priority weight. It shall be recognized that the sum of the weights is indicative of the amount of violated criteria. For instance, the penalty factor is indicative of the number of violated criteria. If a certain possible outcome's criterion satisfies the requirements, it will be given a score equal to its priority weight, otherwise it will be given a score of zero. If the sum of the criteria scores equals one (1), then it shall be understood that the possible outcome has satisfied all the requirements and that there are no violated criteria.

Moreover, according to one embodiment, the algorithm 900 applies a compactness factor CF 318 to each m×n possible outcome. The compactness factor CF is adapted to measure the quality of dispersion by calculating the average Manhattan distance between each possible outcome's constraint and the barycenter of all values under the same type of criteria. The attributes of each element in the compactness factor are then normalized and converted for consistency to a non-dimensional structure CFₙₒᵣₘ as shown in line 18 of algorithm 900 by using the min/max values recorded for all similar elements.

Afterwards, the horizontal concatenation horzcat of the two sums S_{PF} and S_{CF} are computed as per line 20 of algorithm 900 and is a reference or a base for ranking the possible outcomes 320. And since the scores of the SPF range in [−1,0], two subsets are extracted from horzcat and the two subsets correspond to either SPF=0 or SPF<0, such as indicated by attributes “P” and “N” respectively.

Both subsets of possible outcomes “P” and “N” are then sorted in the descending order as follows:
“P” is indicative of whether or not there exists feasible possible outcomes having fulfilled all the constraints. Therefore, “P” (i.e., where SPF=0) are sorted according to their SCF scores. Higher values of SCF scores imply that the possible outcome is situated in the sparse region, and it has better chances to be ranked first.
“N” is indicative of a violation of at least one constraint and corresponds to either a non-feasible or a marginally-feasible possible outcome. The possible outcomes in “N” are compared with the corresponding SPF scores instead. In the case of equal SPF scores, the possible outcomes in “N” will be located in the indifference space where they cannot be differentiated, the SCF scores are then used to discern them

Once done, the sorted Pₛₒᵣₜ and Nₛₒᵣₜ are vertically concatenated to be in the same size as horzcat and to get the indices where each member in vertcat is mapped with itself in horzcat. These indices represent in fact the ranking of possible outcomes 320 in the decision matrix.

The SAGA method 304 takes into consideration all possible outcomes regardless of whether all the criteria values for a possible outcome fall within an acceptable range or not, the method of determining a preliminary number of UAVs to deploy 204 considers all possible outcomes in order to retain or reject such a possible outcome if a satisfactory performance is good enough even if it is not optimal.

In some embodiments, the SAGA method 304 determines the ranking accuracy of each m×n possible outcome 322 by applying corresponding importance weights that are expressed as penalty factors (PF).

In some embodiments, the improved-SAGA method 902, as illustrated in FIG. 9B, is a multi-objective rule-based decision-making method, where the following arguments are used to launch the selection process and eventually identify the best option that satisfies or is closest to the preferences of a user:
An m×n decision matrix of options (contains m possible outcomes, and each one has n criteria).
An array of QoS (quality of service) constraints imposed by the user.
An array of importance weights reflecting the priority that should be assigned to each criterion in the decision matrix. This array can be user-optional and therefore the method is equipped with other mechanisms to provide such array to the matrix. In this way, the burden placed on the user is mitigated.
An additional array acting as a bonding connector between the user-imposed constraints.

An example is illustrated below. A decision matrix of ten possible outcomes for five criteria is shown in Table 1:

TABLE 1

| COVERAGE | ENDUR- | TRANSMISSION | | IMAGE |
|---|---|---|---|---|
| LEVEL | ANCE | RANGE | COST | RESOLUTION |
| 60.96 | 18 | 3560.20 | 2007 | 0.21667 |
| 19.11 | 31 | 996.80 | 13548 | 0.1750 |
| 79.31 | 31 | 2345.00 | 6800 | 0.4117 |
| 23.90 | 21 | 4100.60 | 1598 | 0.2453 |
| 33.51 | 30 | 1319.50 | 21588 | 0.2009 |
| 58.91 | 31 | 1750.00 | 13548 | 0.3073 |
| 19.42 | 36 | 1049.30 | 14289 | 0.07381 |
| 38.84 | 30 | 1049.30 | 39578 | 0.1598 |
| 38.21 | 36 | 996.80 | 31176 | 0.0701 |
| 67.38 | 36 | 2899.40 | 6495 | 0.2039 |

An example of priority weights is shown in Table 2:

TABLE 2

| COVERAGE | ENDUR- | TRANSMISSION | | IMAGE |
|---|---|---|---|---|
| LEVEL | ANCE | RANGE | COST | RESOLUTION |
| 0.2 | 0.2 | 0.2 | 0.2 | 0.2 |

Two examples of user constraints and their connectors (row 2: logical operators; row 3: linkers) are shown in Tables 3 and 4, respectively, where { } denotes an empty set:

TABLE 3

| COVERAGE | ENDUR- | TRANSMISSION | | IMAGE |
|---|---|---|---|---|
| LEVEL | ANCE | RANGE | COST | RESOLUTION |
| 60 | 30 | 3000 | 7000 | 0.2 |
| ≥ | ≥ | ≤ | ≤ | ≥ |
| {} | {} | {} | {} | {} |

TABLE 4

| COVERAGE | ENDUR- | TRANSMISSION | | IMAGE |
|---|---|---|---|---|
| LEVEL | ANCE | RANGE | COST | RESOLUTION |
| 60 | 30 | 2000, 3000 | 7000 | High |
| ≥ | ≥ | ≥, ≤ | ≤ | ≥ |
| {} | {} | {&} | {} | {} |

The user can subjectively state his or her preferences, which are fed to the method as constraints, as a single numerical value, a word-based term, and/or an interval of values (numerical or textual). In some embodiments, linguistic quantifiers such as extremely high, very high, high, moderately high, moderate, moderately low, low, very low and extremely low may be used instead of logic operators. In some embodiments, an artificially intelligent module based on machine learning (ML) and data mining may be used to convert other textual terms (e.g., fast, cheap, small, etc.) as one of the built-in linguistic quantifiers in the method. For instance, the method will convert the term “cheap” to “low”.

In some embodiments, the method 902 further uses a distance factor (DF) in addition to the penalty factor (PF) and the compactness factor (CF). An example algorithm 330 for the DF is illustrated in FIG. 3C. A decision matrix A of size (m×n) is provided, where m is the number of possible outcomes. A 1×n sized cell-array of constraints C is provided, where each cell in the array can have one or k elements. The total number of elements that a call may have, is denoted as ∥C{j}∥ and j=1, . . . , n. A temporary distance matrix having the same dimensions as the decision matrix is computed, where each element in the decision matrix A[i,j] will be assigned a specific score according to the Euclidean distance between its normalized value and the desired constraint attributed to it. Final DF scores are obtained by adding together all the column elements for each row in order to get an m×1 array.

The DF factor for an element in the decision matrix is obtained by measuring the distance between such an element and the user-imposed constraints, whereas the CF factor is obtained by measuring how close or far that element is from the average score of all the values falling under the same type of criteria in the decision matrix. Indeed, the CF score is computed as follows:

$${CF}_{temp} = [ \begin{matrix}{η}_{1} & … & {η}_{n} \\ … & … & … \\ {η}_{1} & … & {η}_{n}\end{matrix} ] \times [ \begin{matrix}{A}_{1 , 1}^{norm} - {\overline{A}}_{1}^{norm} & … & {A}_{1 , n}^{norm} - {\overline{A}}_{n}^{norm} \\ … & … & … \\ {A}_{m , 1}^{norm} - {\overline{A}}_{1}^{norm} & … & {A}_{m , n}^{norm} - {\overline{A}}_{n}^{norm}\end{matrix} ] ;$$

where A_{i,j}^{norm} represents the j^{th} value of the i^{th} possible outcome in the normalized decision matrix, Āⱼ^{norm} is the average value of all elements in the j^{th} column, and ηj is a particular coefficient. In some embodiments, the user can only assign a single-valued constraints array and each element in the decision matrix is evaluated based on two connecting rules: whether being ≥ or ≤ to the imposed constraint. Therefore, τⱼ can have two values:−1 for the criteria that are to be maximized (i.e., ≥) or 1 for the criteria to be minimized (i.e., ≤). In other embodiments, the user is flexibly able to assign single and many-valued constraints and each one of them has a connecting logical operator, which can be: ≥, >, =, <, ≤. The parameter ηⱼ is obtained as follows:

$${τ}_{j} = max ( {η}_{j , k}^{temp} ) , j = 1 , … , n criteria and k = 1 , … , ‖ C \{ j \} ‖ \\ {τ}_{j , k}^{temp} = \{ \begin{matrix}- 1 if logical operator ( j , k ) is \geq or > \\ 1 if logical operator ( j , k ) is < or \leq \\ α otherwise\end{matrix}$$

The computed CFₜₑₘₚ, which is equal in size with the decision matrix (i.e., m×n) is then normalized. The final CF scores are obtained by adding together all the column elements for each row in the normalized CF^{norm} and then multiplying by −1 in order to get an m×1 array:

$${CF}_{i} = - {\sum }_{j = 1}^{n} {CF}_{i , j}^{norm} and i = 1 , … , m$$

Using the data from the example of Tables 1, 2, and 4, normalized possible outcomes and normalized constraints are shown in Tables 5 and 6, respectively.

TABLE 5

| COVERAGE | ENDUR- | TRANSMISSION | | IMAGE |
|---|---|---|---|---|
| LEVEL | ANCE | RANGE | COST | RESOLUTION |
| 4 | −4 | 4 | −4 | 2 |
| −4 | 3 | −4 | −2 | −3 |
| 4 | 3 | 3 | −4 | 4 |
| 3 | −4 | 4 | −4 | 3 |
| −4 | 0 | −4 | 3 | −2 |
| 3 | 3 | −3 | −2 | 4 |
| −4 | 4 | −4 | −2 | −4 |
| −3 | 0 | −4 | 4 | −3 |
| −3 | 4 | −4 | 4 | −4 |
| 4 | 4 | 4 | −4 | −2 |

TABLE 6

| COVERAGE | ENDUR- | TRANSMISSION | | IMAGE |
|---|---|---|---|---|
| LEVEL | ANCE | RANGE | COST | RESOLUTION |
| {3} | {0} | {−1 4} | {−4} | {2} |

The DF scores for each normalized possible outcome are shown in Table 7.

TABLE 7
DF Scores

10
26
10
10
27
14
28
28
33
14

Referring to line 4 of the algorithm 330, the “D” values for the first possible outcome are: [{1} {16} {25, 0} {0} {0}]. The third column has two values since the corresponding column in the constraints array also has two values. Referring to line 6, the temporary “D” values for the first possible outcome are: [{1} {4} {5} {0} {0}]. Therefore, the final DF score for the first outcome is 10.

The CF scores are shown in Table 8.

TABLE 8
CF Scores

−2.8571
−3.0487
−3.0084
−2.1905
−1.8535
−3.1000
−3.6321
−0.9487
−1.6321
−1.8738

The η matrix needed for the CF computation is given as per Table 9.

TABLE 9

| COVERAGE | ENDUR- | TRANSMISSION | | IMAGE |
|---|---|---|---|---|
| LEVEL | ANCE | RANGE | COST | RESOLUTION |
| −1 | −1 | 1 | 1 | −1 |
| −1 | −1 | 1 | 1 | −1 |
| −1 | −1 | 1 | 1 | −1 |
| −1 | −1 | 1 | 1 | −1 |
| −1 | −1 | 1 | 1 | −1 |
| −1 | −1 | 1 | 1 | −1 |
| −1 | −1 | 1 | 1 | −1 |
| −1 | −1 | 1 | 1 | −1 |
| −1 | −1 | 1 | 1 | −1 |
| −1 | −1 | 1 | 1 | −1 |

The first, second and fifth column have the value ‘−1’ because the logical operators of the corresponding constraints is ‘≥’. The fourth column has the value 1 because the logical operator of the corresponding constraint is ‘≤’. Although the third column has two logical operators which correspond relatively to ‘−1’ and ‘1’, the maximum is taken.

The average scores of the normalized decision matrix are: [0 1.3 −0.8 −1.1 −0.5]. The temporary CF values for the first possible outcomes are: [−4 −5.3 4.8 2.9 −2.5]. The normalized CF values for the first possible outcomes are: [1 1 0 0.5238 0.3333]. Therefore, the final CF Score for the first possible outcome is −2.8571.

As described hereinabove, the method for selecting and deploying a set of UAVs over a graphical area of interest comprises selecting a preliminary number of UAVs for deployment by defining possible outcomes for a plurality of criteria having predefined constraints and associated priority weights, computing a PF score (SPF) based on whether or not each of the possible outcomes violate the predefined constraints, computing a CF score (SCF) based on how close or far the possible outcomes are from an average score of all values falling under a same type of criteria, ranking the possible outcomes using SPF and SCF, and selecting the preliminary number of UAVs based on the ranking. In some embodiments, a distance factor score (SDF) is also computed, by measuring a distance between the possible outcomes for the plurality of criteria and the corresponding constraints for the criteria and used in the ranking.

### Establishing a Positioning of Preliminary UAVs

Following the determination of a preliminary number of UAVs to deploy, as further presented in FIG. 2, the method 202 includes establishing 206 a positioning of each preliminary UAV. The positioning of each preliminary UAV is established 206 according to a 2D reference. In fact, according to one embodiment, it is assumed that all the UAVs are flying at the same height and that each UAV covers a zone that is associated to a respective sub-area 105 of an area of interest 104. The positioning of each UAV is established 206 according to a variety of conditions or criteria. For instance, a first condition can be to provide an adequate coverage of the area of interest 104. Another condition can be to limit as much as possible an overlapping of coverage zones respectively provided by each UAV. Yet another condition can be to limit as much as possible an overlapping of a coverage zone provided by a UAV and a coverage zone that is outside the perimeter of the area of interest 104.

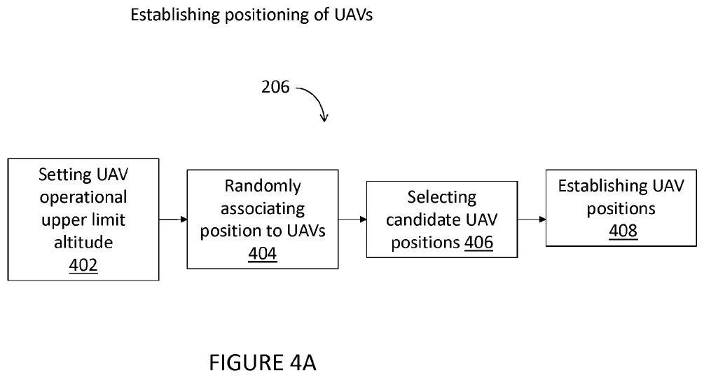

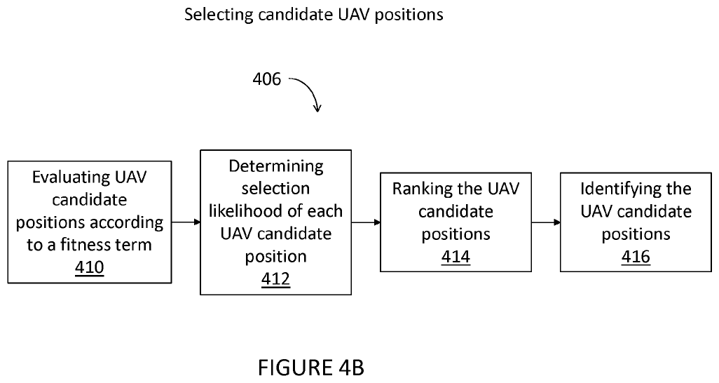

According to one embodiment, the UAV coverage zone radius is defined by a set of predetermined parameters such as UAV location, UAV altitude, UAV camera field of view or UAV antenna transmission power and beam width or a combination thereof. Notice that varying UAV altitude can impact the coverage zone radius in addition to causing physical UAV collisions and creating Doppler shifts in the communication channels. Moreover, increasing the altitude to provide a wider coverage level can increase the loss of signal (LoS) probability, decrease imaging resolution, and increase path-loss attenuation. In order to limit such trade-offs and challenges, in accordance with one embodiment, it is assumed that the UAVs are required to operate at a same altitude and are considered as stationary Low Altitude Platforms (LAPs). For instance, the altitude of the UAVs may be less than 3000 meters. As presented in FIG. 4A, the establishing 206 includes setting 402 an upper limit on the operational altitude, then randomly associating a position to each UAV 404, then selecting UAV candidate positions 406 and determining preliminary UAV positions 408.

According to one embodiment, the operational upper limit altitude for each case presented in the table 800 of FIG. 8 is calculated or set 402 according to the following formula, in accordance with the shape of the sub-area 104:

$$h = \{ \begin{matrix}\sqrt{\frac{{CL}_{pet}}{n}} \times \frac{l}{20 tan ( θ / 2 )} & ( C ) \\ \sqrt{\frac{{CL}_{pet}}{n π}} \times \frac{l}{10 tan ( θ / 2 )} & ( S ) \\ \sqrt{\frac{{CL}_{pet} \sqrt{3}}{n π}} \times \frac{l}{20 tan ( θ / 2 )} & ( T )\end{matrix} \qquad ( 2 )$$

Where l is the radius or side length of the area of interest 104, n is the number of UAVs and θ is the camera's HFOV (Horizontal field of view). Consequently, the UAV coverage radius is calculated by:

$$r = h . tan ( θ / 2 ) \qquad ( 3 )$$

Accordingly, the coverage problem is modeled as a multiple circles placement problem. The multiple circles are respectively associated to the coverage zone of each UAV, and the placement problem is formulated as follows:

$$max Coverage {⟹}^{s . t .} \{ \begin{matrix}{F}_{1} = min {\sum }_{i = 1}^{n} {\sum }_{j = i - 1}^{n} ovlp ( {u}_{i} , {u}_{j} ) \\ {F}_{2} = min {\sum }_{i = 1}^{n} ovlp ( {u}_{i} , AoI )\end{matrix} \qquad ( 4 )$$

Where n is the total number of UAVs, ovlp(ui, uj) is the overlapping between the coverage zones of two UAVs separated by a distance dij. The ovlp(ui, uj) is calculated as shown below:

$$ovlp ( {u}_{i} , {u}_{j} ) = \{ \begin{matrix}0 & if {d}_{i , j} \geq 2 r \\ π . {r}^{2} & if {d}_{i , j} = 0 \\ δ & if 0 < {d}_{i , j} < 2 r\end{matrix} \qquad ( 5 )$$

Where δ represents the partial overlapping value between two UAV coverage zones and is measured as indicated below:

$$δ = 2 {r}^{2} a tan 2 ( √ {r}^{2} - \frac{{d}_{i , j}^{2}}{4} , \frac{{d}_{i , j}}{2} ) - {d}_{i , j} √ {r}^{2} - \frac{{d}_{i , j}^{2}}{4} \qquad ( 6 )$$

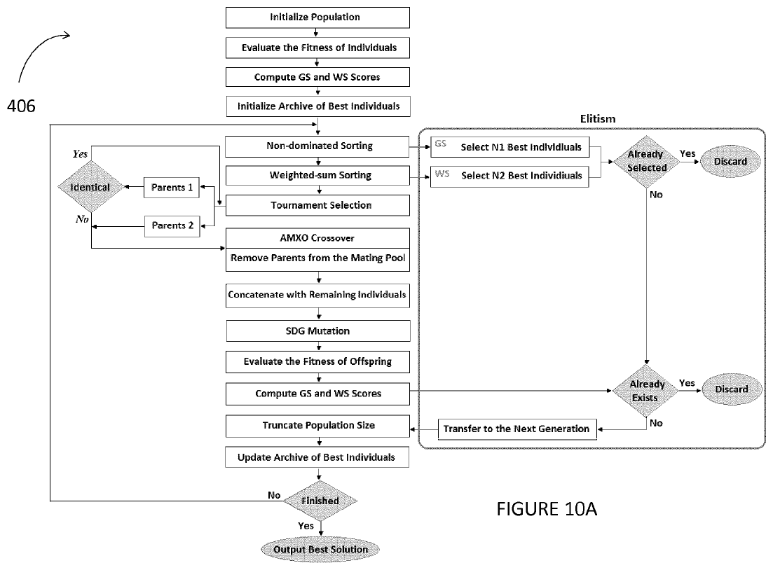

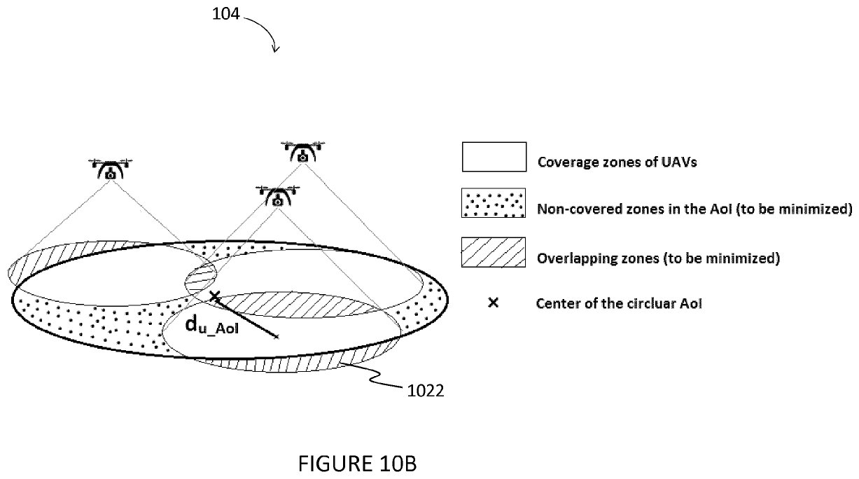

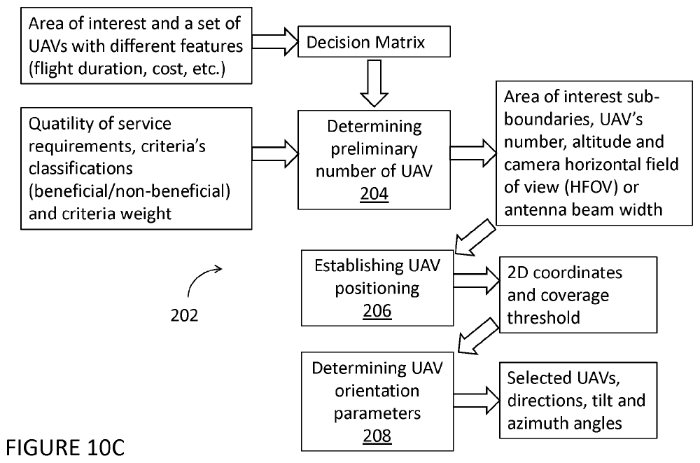

ovlp(ui,AoI) is the overlapping 1022 between the coverage zone of a UAV and zone outside the perimeter of the area of interest, as depicted in FIG. 10B. It is calculated according to the shape of the area of interest. For instance, in the case of a circular area of interest 104, the ovlp(ui,AoI) defined as follows:

$$ovlp ( {u}_{i} , AoI ) = \{ \begin{matrix}0 & if {d}_{u , i - AoI} \leq {R}_{AoI} \\ π . {r}^{2} - δ & otherwise\end{matrix} \qquad ( 7 )$$

Where dui-AoI is the distance between the UAV's coverage zone center and the center of the circular area of interest 104, as shown in FIG. 10B. For rectangular and triangular areas of interest, the overlapping regions outside one of the edges is calculated with reference to the formula of circular segment or portion of circle above chord as follows:

$$ovlp ( {u}_{i} , AoI ) = \{ \begin{matrix}{\sum }_{j = 1 , … , 4} G ( r , r - {d}_{j}^{⊥} ) & if {d}_{j}^{⊥} < r \\ 0 & otherwise\end{matrix} \qquad ( 8 )$$

$$ovlp ( {u}_{i} , AoI ) = \{ \begin{matrix}π {r}^{2} & if {u}_{i} ∉ AoI ∧ {d}^{⊥} \geq r \\ π {r}^{2} - G ( r , r - {d}^{⊥} ) & if {u}_{i} ∉ AoI ∧ {d}^{⊥} < r \\ {\sum }_{j = 1 , 3 , 3} G ( r , r - {d}_{j}^{⊥} ) & if {u}_{i} ∈ AoI ∧ {d}_{j}^{⊥} < r \\ 0 & otherwise\end{matrix} \qquad ( 9 )$$

$$G ( r . ξ ) = {r}^{2} {cos}^{- 1} ( r - \frac{ξ}{r} ) = ( r - ξ ) \sqrt{2 r ξ - {ξ}^{2}} \qquad ( 10 )$$

Where ξ is the altitude measured at the midpoint of the outer arc's base. Equation (8) is meant for a square shaped area of interest 104 while equation (9) is formulated for a triangular shaped area of interest. In both equations, dⱼ^{⊥} comprises all nearest perpendicular distances from a UAV to one of the areas-of-interest's edges. The condition in (9) about the UAV being inside or outside the area of interest is raised since the triangular areas of interest three vertices are presumed to be inscribed inside a rectangle for algorithmic purposes.

According to one embodiment as further presented in FIG. 4A, once the upper limit altitude of the UAVs is set 402, the method 206 further includes randomly associating a population of candidate UAV positions 404 over the area of interest 104, for each UAV. For instance, a real coding (float point) scheme is provided for the individual representation, where each individual or chromosome has n genes each representing the 2D coordinates of a UAV. The population is initialized randomly over the area of interest 104. That is the initial position of the n^{th} UAV is (×n0, yn0)˜U(LB, UB) taken from a uniform distribution, where LB, UB are respectively the lower and upper bounds of the area of interest 104 or the rectangle area inscribing the area.

Then, as further presented by the method 206 of FIG. 4A and as concurrently presented in FIG. 4B, UAV candidate positions are selected 406 by evaluating 410 UAV candidate positions, then determining a selection likelihood 412 of each UAV candidate position, then ranking 414 the UAV candidate positions and identifying 416 the UAV candidate positions.

As presented in FIG. 4B, the UAV candidate positions are evaluated 410 with respect to at least one fitness term. In this case, two fitness terms F1 and F2 are used, as previously described in equations (5), (7), (8) and (9) in order to quantify the quality of each individual in the present population.

The fitness terms F1 and F2 are indicative of an overlapping condition. In fact, the less each UAV's coverage radius overlaps another UAV's coverage zone or with outside the borders of the area of interest, the better its coverage zone and the better the solution.

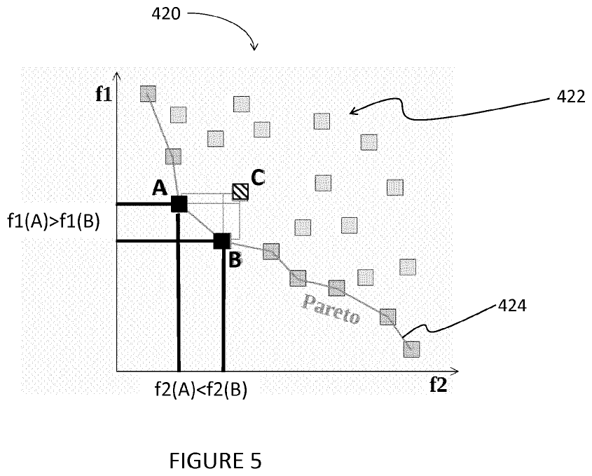

Then, as further presented by the method of selecting candidate UAV positions 406 of FIG. 4B, according to one embodiment, the selection likelihood of each UAV candidate position is determined 412 according to a selection operator such as a guided selection (GS) operator and a weighted sum (WS) operator. The GS operator has a relatively low computational complexity and is adapted to maintain the population diversity while enhancing the distribution of non-dominated solutions provided by a Pareto front 424 as presented in FIG. 5. For instance, there is presented in graph 420 of FIG. 5 a group of possible solutions 422 according to fitness functions f1 and f2, each solution is depicted as a square point in the graph 420. The solutions identified as A and B that are alongside the Pareto front 424 are solutions that are non-dominated solutions. That is, the solutions A and B equally qualify with respect to the fitness terms f1 and f2.

The GS operator allows to enhance the distribution of non-dominated solutions and to maintain the diversity of the population (of candidate solutions) by giving high priorities to those satisfying a predetermined condition. The equation describing the GS is presented in the following equation (11):

$${GS}_{i} = \{ \begin{matrix}- ∞ & if ∃ ( {F}_{{1}_{i}} , {F}_{{2}_{i}} ) ∈ [ 0 , 0 ] \\ \frac{- {\sum }_{j = 1}^{2} \vert {F}_{{j}_{i}} - mean ( {F}_{j} ) \vert}{min ( {F}_{{1}_{i}} , {F}_{{2}_{i}} )} & otherwise\end{matrix} \qquad ( 11 )$$

A selection likelihood for the i^{th} individual is increased if at least one of its fitness (F1 or F2) values belongs to a goal vector [0,0], which is indicative of zero overlapping, a −∞ score is assigned to such i^{th} individual. Otherwise, the selection will depend on the distance between the j^{th} individual fitness (F1 and F2) values and the barycentre of all j^{th} objectives. In fact, the selection likelihood is provided according to either the i^{th} individual fitness (F1 or F2) values or according to j^{th} individual fitness (F1 and F2) values.

Moreover, the selection likelihood can also be determined according to a weighted sum (WS) operator, as follows:

$${WS}_{i} = {\sum }_{j = 1}^{2} {W}_{j} {F}_{ji} \qquad ( 12 )$$

Where wⱼ is a weight associated to each fitness term (F1 and F2) and is indicative of an importance factor of each fitness function. According to one embodiment, the sum of the weight associated to each fitness term (F1 and F2) is equal to one (1). In the present case, the fitness terms (F1 and F2) are equally important, therefore the w₁ of F1 is equal to the w₂ of F2 and w₁=w₂=0.5 and consequently w₁+w₂=1.

In some cases, the fitness terms are conflicting, for instance if fitness term F1 is associated to reducing overlapping between UAV coverage zones and fitness term F2 is associated to reducing overlapping outside the area of interest, a conflict might arise. In fact, reducing overlapping between UAV coverage zones can result in increasing overlapping outside the area of interest and vice versa. There may exist many Pareto optimal equally good solutions and therefore the weighted sum provides an additional method to select a fittest non-dominated solution, that is the solution having a lower WS score. According to one embodiment, the WS operator is used at various selection steps, such as: selecting some individuals for elitism, deciding the winner during the tournament selection and archiving the fittest solution in each generation.

According to one embodiment, the selection likelihood is either determined 412 according to the GS operator or according to the WS operator or both. It shall be recognized however that any other type of suitable selection operator or combination thereof can be used to determine the selection likelihood of each UAV candidate position.

Then according to one embodiment, as further presented in the method of selecting UAV candidate positions 406 of FIG. 4B, the UAV candidate positions are ranked 414 according to the determined selection likelihood 412. In this case, the selection likelihood is either determined 412 according to the GS operator or according to the WS operator, therefore the ranking is performed according to either a GS score, a WS score or both and a ranking value is associated to each UAV candidate position.

Then, as further presented in the method 406 of FIG. 4B, the UAV candidate position combination having a highest-ranking value is identified 416 as the UAV candidate positions and a preliminary UAV position is thereby determined for each UAV 408 (see FIG. 4A).

According to one embodiment, as presented in FIG. 10A, the candidate positions are selected 406 according to an iterative comparison-based <w-tournament selection based on their rank and WS scores defined for each two random candidate positions p and q as follows:

$$p {≺}_{w q} if \{ \begin{matrix}{rank}_{p} < {rank}_{q} \\ or \\ {rank}_{p} = {rank}_{q} and {WS}_{p} < {WS}_{q}\end{matrix} \qquad ( 13 )$$

According to one embodiment, in order to improve the diversity of next candidate positions also identified as chromosomes, the candidate positions are selected only once in order to allow other suitable candidate positions to be selected. That is, two candidate positions are mated or crossed-over only once in order to improve the diversity of candidate positions by producing two candidate position offsprings. For instance, real-coded genetic operators (AMXO Crossover) are defined as follows:

$$\begin{matrix}{y}_{i}^{( 1 )} = {α}_{i} {x}_{i}^{( 1 )} + ( 1 - {α}_{i} ) {x}_{i}^{( 2 )} \\ {y}_{i}^{( 2 )} = {α}_{i} {x}_{i}^{( 2 )} + ( 1 - {α}_{i} ) {x}_{i}^{( 1 )}\end{matrix} \qquad ( 14 )$$

Where xᵢ and yᵢ are the i^{th} parent and offspring respectively and αᵢ˜U(0,1) are generations-independent uniform random numbers.

A strength-decreasing Gaussian mutation (SDG) provides possible alterations with a constant probability pₘ which is a mutation rate on some random genes of some candidate positions (after combining the crossover offspring with the surviving ones that have not been chosen as parents). The candidate position that undergoes a mutation is given by:

$${x}_{i}^{′} = {x}_{i} + N ( ( ) . σ ) ( 1 - \frac{Current\_Gen}{Max\_Gen} ) \qquad ( 15 )$$

where N(0, σ) is the normal distribution with zero mean and a standard deviation σ that should be related to the bounds LB/UB.

The mutation strength gets close to zero as the number of generations increases in order to search the space normally in the initial generations and to refine and explore the space locally in the later generations.

Moreover, some fittest solutions are copied directly without changes to the next generation; hence, the best-performing solutions ever obtained will not be lost. At first, a number N1 of candidate positions are selected according to their GS ranking (lower values are preferred). An additional number N2 of candidate positions are selected according to their WS scores, if they have not yet been chosen. N1 and N2 are copies, so the original ones still exist to undergo genetic operations.

The best solutions found in each generation i.e., the non-dominated solution having the minimal GS ranking, are respectively archived. Once the maximum number of generations is reached or a solution that perfectly attains the goal vector is attained, the method 206 returns the fittest archived solution and the preliminary positioning of UAVs is thereby established 408.

### Determining UAVs' Cameras/Antennas Orientations

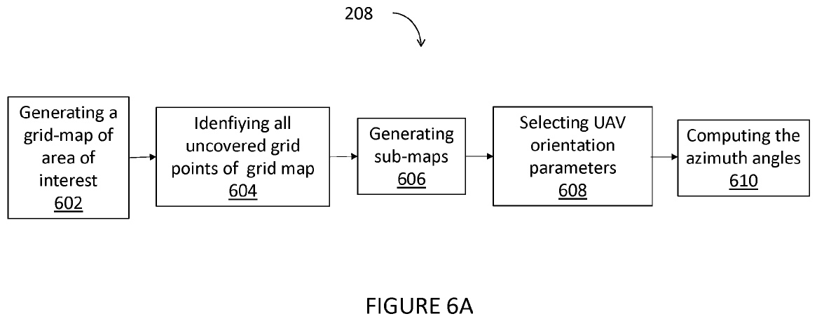

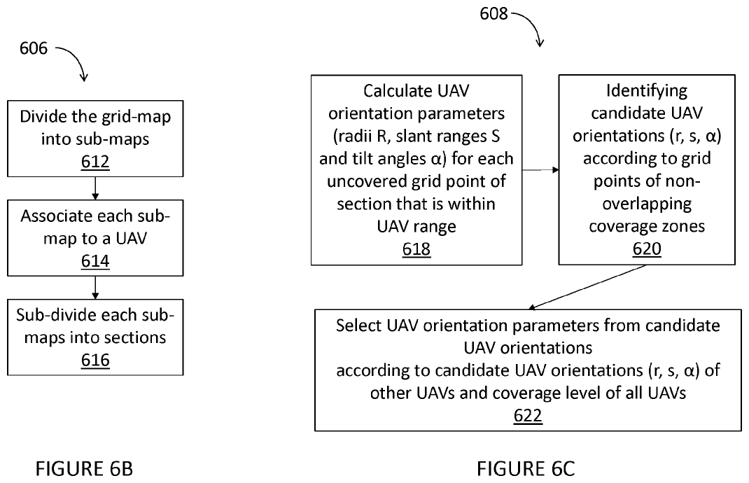

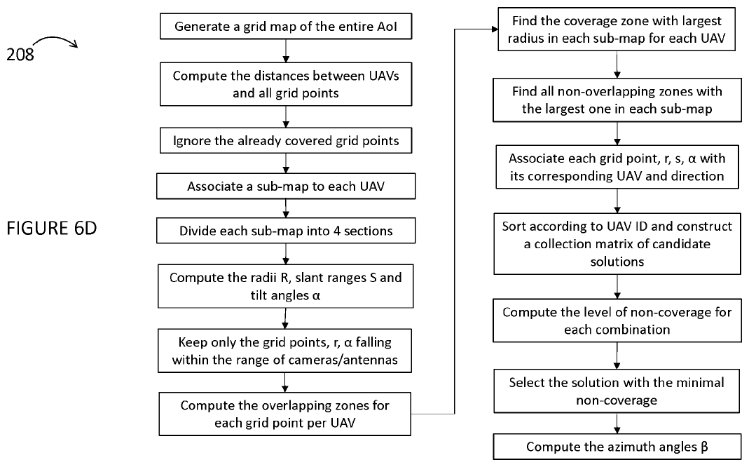

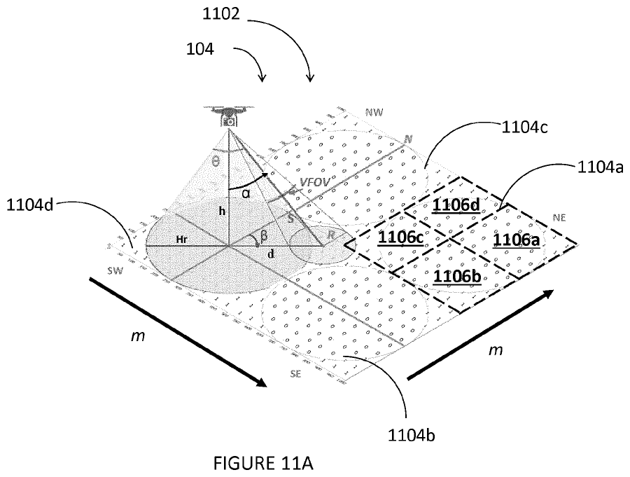

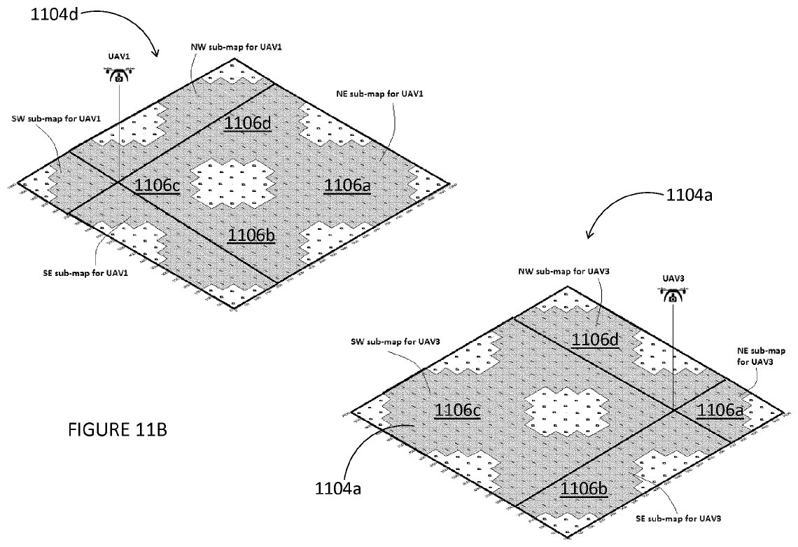

Once the positioning of the preliminary UAVs is established 206 according to an acceptable coverage level threshold, there still are some non-covered areas, as it is not always possible to uniformly and totally cover a given area of interest while respecting the same conditions or criteria such as limiting overlapping conditions, as shown by coverage grid-map 1102 associated to area of interest 104 of FIG. 11A. Moreover, as presented in the table 800 of FIG. 8, for instance, despite the use of twelve (12) UAVs, the coverage level reaches only approximately 75 to 78%, depending on the shape of the area of interest 104. In order to provide an adequate coverage of the area of interest 104, the orientation of each UAV must be controlled according to a respective group of orientation parameters. Therefore, the method 202 further includes determining UAV orientation parameters 208 for each UAV according to a predetermined group of cardinal directions, as presented concurrently in FIGS. 2 and 6A.

According to one embodiment as presented in FIG. 6A, the method of determining UAV orientation parameters 208 includes generating 602 an m×m grid-map according to the area of interest 104, identifying 604 all uncovered grid points of the grid-map, generating 606 sub-maps according to the predetermined group of cardinal directions, determining 608 UAV orientation parameters and computing 610 associated azimuth angles.

As further presented in FIG. 11A, an m×m grid-map 1102 is generated 602 according to the area of interest 104 and the grid map 1102 is indicative of the whole area of interest 104. Then all uncovered grid points of the grid-map are identified 604 according to an Euclidian distance measured between UAVs coordinates projected in a 2D plane of the grid-map 1102. A grid point is considered to be covered if there exists at least a distance between the grid point and any UAV that is inferior to a Horizontal coverage radius (Hr). As can be noticed by the grid-map 1102 the grid points that are covered by a UAV are denoted by ‘0’ and those that are not, are denoted by ‘1’. Conversely, the level of non-covered grid points is quantified by calculating the sum of ‘1’ elements.

According to one embodiment as presented in FIGS. 6A, 6B, 11A and 11B, sub-maps are generated 606 by dividing 612 the grid-map 1102 into sub-maps (1104a, 1104b, 1104c, 1104d) that are indicative of each sub-area 105. Each sub-map (1104a, 1104b, 1104c, 1104d) is then associated 614 to a UAV coverage zone. The sub-maps are further sub-divided 616 into sections (1106a, 1106b, 1106c, 1106d) in accordance with a group of predetermined cardinal directions such as North-East, South-East, South-West and North-West. It shall be recognized that the number of predetermined cardinal directions can vary depending on the area of interest, the area of application, the required precision level, etc.

According to one embodiment as presented in FIGS. 6C and 11A, the UAV orientation parameters are determined 608 by calculating 618 UAV orientation parameters for each uncovered grid point of each section (1106a, 1106b, 1106c, 1106d) that is within UAV range. Then, identifying 620 candidate UAV orientation parameters that are associated to non-overlapping coverage zones according to a predetermine condition. Then selecting 622 UAV orientation parameters from candidate UAV orientation parameters according to candidate UAV orientation parameters and coverage level of other UAVs associated to the area of interest 104.

As further presented in FIG. 11A, the grid-map 1102 is divided 612 into sub-maps (1104a, 1104b, 1104c, 1104d), according to the determined 204 preliminary number of UAVs and the established 206 positioning of each UAV. Each sub-map (1104a, 1104b, 1104c, 1104d) is associated 614 to a UAV and each sub-map (1104a, 1104b, 1104c, 1104d) is further sub-divided into sections (1106a, 1106b, 1106c, 1106d), as depicted in dotted lines. In this case, the sections (1106a, 1106b, 1106c, 1106d) are each associated to one of the four cardinal directions (North-East, South-East, North-West and South-west), however it shall be recognized that the sub-maps can be oriented in any other manner, in any other number and have any other shape or combination of shapes.

According to one embodiment, the orientation parameters are determined in a parallel manner for all UAVs and their associated sections (1106a, 1106b, 1106c, 1106d) are considered as sub-problems of a scaled down version from the main problem.

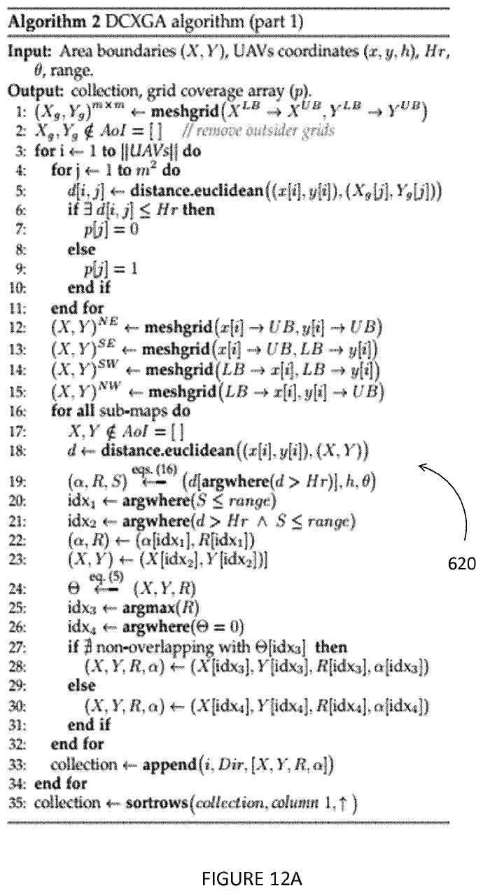

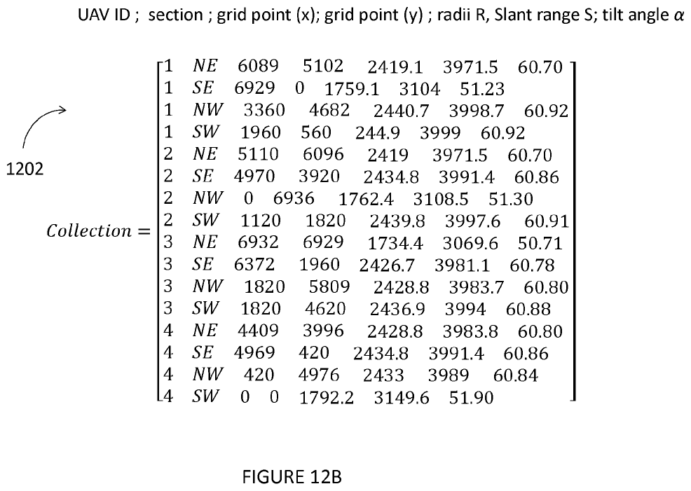

According to one embodiment, for each UAV, orientation parameters associated to each section are calculated 618 according to uncovered grid points that are within the UAV range. For instance, the uncovered grid points that are within the UAV range of one of the sections (1106a, 1106b, 1106c, 1106d) are determined according to the resulting tilt angles α, coverage radii R and slant ranges S and are identified as extended-coverage grid points. The slant ranges S are calculated according to the UAVs altitude and the distances d between the UAV and its corresponding section (1106a, 1106b, 1106c, 1106d) grid points as presented in FIG. 11A. The grid points that are at distance d values that are superior to Hr are identified as not covered by the camera's or antenna's orientation. Only section grid points that are within the tilt angles α and coverage radii R that have indices where slant ranges S fall within the UAVs' cameras/antennas range, as well as section grid points that are at a distance d that is superior to Hr are retained or identified 620 as extended-coverage grid points. In FIG. 12A, those two conditions are specified at line 21 of the algorithm 1200.

The retained or identified extended-coverage grid points for each section are indicative of another coverage region defined by the associated radius R and tilt angle α. The method 608 further verifies 620 if there are other section grid points that are within the UAV range and that do not overlap with another covered region as defined by a retained radii R and tilt angle α that is associated to an extended-coverage grid point of another section or UAV. If such section grid points remain, then they will be retained together with the section grid points of extended-coverage grid points. Otherwise, the only grid points that will be considered in the next iterations are the grid points of the extended-coverage grid points.

In fact, for each section there is produced a sub-solution of retained section grid points, the coverage radii, elevation angles, the corresponding UAVS ID and the section information such as retained in collection array 1202 of FIG. 12B.

According to one embodiment, the overlapping between the coverage zones provided by the retained radii R and section grid points are calculated according to previously described equations (5) and (6) where the section grid points are taken as centers. The method produces a collection 1202 of sub-solution grid points with only the section grid points of the extended-coverage that do not overlap. The collection 1202 includes associated UAV identifier, section identifier, grid point coordinates, coverage radii R, slant ranges S and tilt angles α; otherwise, the sub-map grid point with largest coverage radius is the single sub-solution. Once all the sub-solutions are identified, they will be combined together as one collection matrix and then sorted in the ascending order according to UAVs ID.

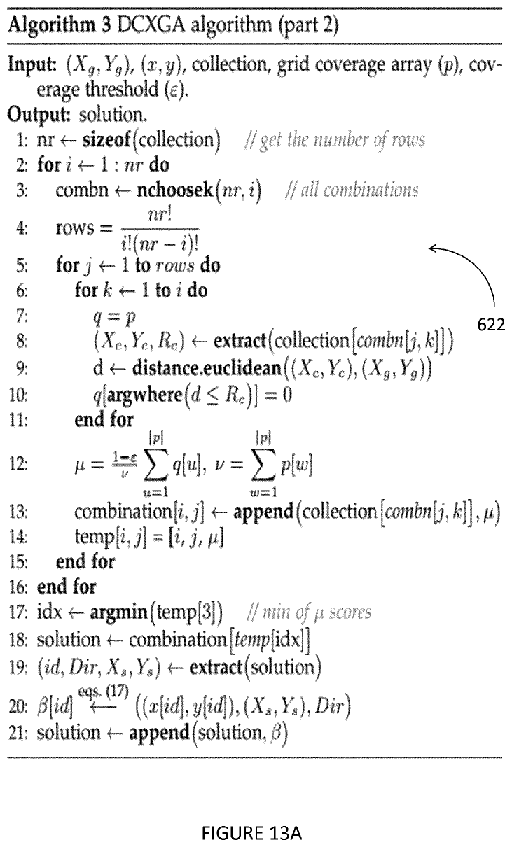

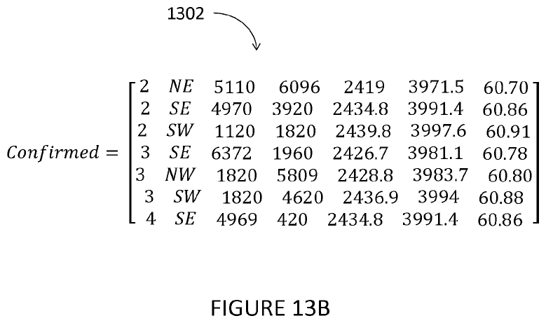

Presented in FIG. 13A is a method of selecting 622 a confirmed group of UAV orientation parameters, such as confirmed group 1302 of FIG. 13B, from a collection of UAV orientation parameters, such as collection 1202 of FIG. 12B. The method uses the sorted collection of sub-solutions 1202, grid coverage array (p) and a coverage level threshold (ε) such as the coverage threshold that is determined by the method 206 of FIG. 10C, according to one embodiment. The grid coverage array (p) is indicative of the number of covered grid points in the grid map 1102 while the UAVs are in an initial coverage state, that is without UAV orientation parameter control, as presented for instance in FIG. 11A.

According to the method of determining a confirmed group of UAV orientation parameters 1300, as presented in FIG. 13A, all possible combinations of orientation parameters provided by the collection matrix 1202 are considered. The binomial coefficients combn indicates the number of all possible combinations of nr items taken i at a time are calculated; where nr is the number of rows in the collection matrix and i∈[1,nr]; combn is an array of nr matrices containing i columns and nr!/i!(nr-i)! rows.

Here, by taking each possibility in combn rows as an index, the corresponding grid coordinates (Xc,Yc) and Rc extracted from the collection of sub-solutions are used to update the grid coverage array by replacing the ‘1’ (indicative of an uncovered grid point) elements with ‘0’ (indicative of a covered grid point) whenever any grid point in the whole grid map has a distance from points centered at (Xc, Yc) which is shorter than Rc, as depicted by UAV position over section 1104c of FIG. 11A.

In fact, further presented by sections 1104d and 1104a another coverage level is determined by calculating the sum of ‘1’ elements in the grid coverage array as stated in line 12 of the method 1300 in FIG. 13A and then each row in the combination matrix of all possibilities will be amended with its relative non-coverage score (μ).

The combination having a lowest non-coverage (μ) score is identified as the optimal or confirmed solution 1302, as depicted in FIG. 13B. According to one embodiment, the confirmed solution is the solution having the lowest number of UAVs or a lowest number of orientation parameters.

Returning to FIG. 6A, for each determined 608 UAV orientation parameter, in order to accurately steer the selected UAVs towards their directional coverage coordinates (Xs, Ys), the method 208 calculates 610 the UAV azimuth angles β, whether by rotating their cameras or by moving around its Pitch and Yaw axes; with reference to the northern direction and according to which sub-map the grid points are pinpointed as defined in the set of equations (17).

$${β}^{NE} = arc tan ( \vert \frac{x - {X}_{s}}{y - {Y}_{s}} \vert ) β \qquad ( 17 a )$$

$${β}^{SE} = 180 ° - {β}^{NE} \qquad ( 17 b )$$

$${β}^{SW} = 180 ° + {β}^{NE} \qquad ( 17 c )$$

$${β}^{NW} = 360 ° - {β}^{NE} \qquad ( 17 d )$$

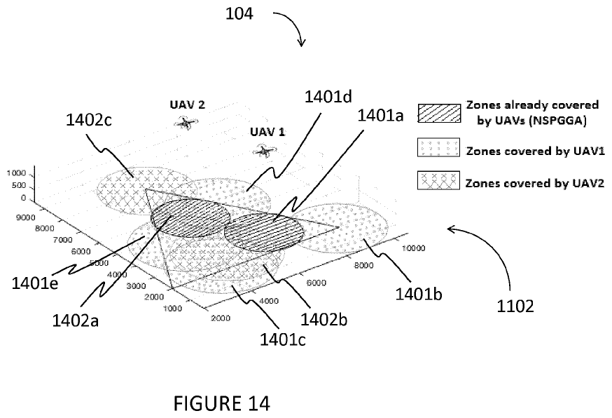

Presented in FIG. 14 is an area of interest 104 having a triangular shape. There are two striped zones 1401a and 1402a that are identified as being already covered according to the positioning of the two UAVs. However, the other zones of the triangular area of interest 104 are uncovered and each UAV is controlled according to the orientation parameters provided by the orientation parameter determination method 208. As can be noticed, UAV1 is controlled to modify its orientation parameter to successively cover zones 1401a, 1401b, 1401c, 1401d and 1401e and UAV2 is controlled to modify its orientation parameter to successively cover zones 1402a, 1402b and 1402c.

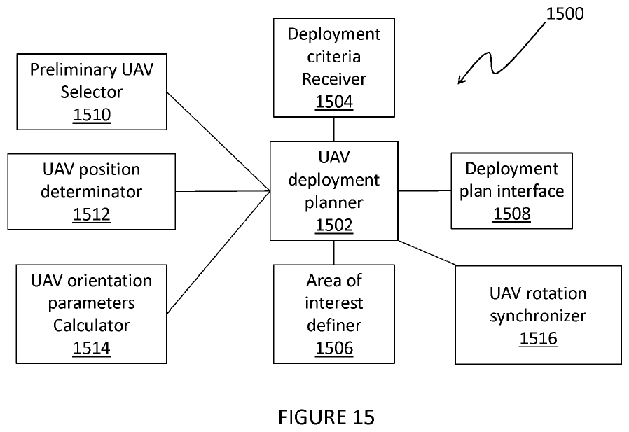

Presented in FIG. 15 is a UAV deployment planning system 1500 having a UAV deployment planning module 1502. The planning module 1502 is connected to a deployment criteria-receiving module 1504 and to an area of interest definition module or selection module 1506. The deployment criteria receiving module 1504 can be a user interface or connected to another system whereby a user can define a variety of deployment criteria for a specific UAV deployment mission such as the coverage level, the imaging resolution, the RSS (received signal strength) index, etc. The area of interest definition module 1506 can be a map interface module or a module connected to a system adapted to provide a precise geographical information concerning a region of interest according to which a deployment mission is to be planned. Based on the information provided by deployment criteria receiving module 1504 and the area of interest definition module 1506, the UAV deployment planning system 1500 is adapted to determine a deployment plan and transfer the deployment plan to a deployment plan communication module 1508. The deployment plan communication module 1508 can be a user interface, adapted to communicate or present the deployment plan to a user. The deployment plan communication module 1508 can also have a transceiver module adapted to transceive the deployment plan to another system such as another deployment planning module 1502 or to a UAV controlling module.

The UAV deployment planning module 1502 is adapted to establish the deployment plan in accordance with a group of UAVs determined by a preliminary UAV selection module 1510, with geographical UAV positions provided by a UAV position determination module 1512 and with UAV orientation parameters provided by a UAV orientation parameter calculation module 1514. In some embodiments, a UAV rotation synchronizer is also present, as will be described in more detail below.

The preliminary UAV selection module 1510 is adapted to provide a preliminary number of UAVs to deploy based on the group of received criteria. According to one embodiment, the preliminary UAV selection module is adapted to perform the method of determining a preliminary number of UAVs to deploy 204, as concurrently presented in FIG. 3.

The UAV position determination module 1512 is adapted to determine a geographical position of each UAV according to the preliminary number of UAVs determined by the selection module 1510 and according to an upper limit altitude criterion. According to one embodiment, the UAV position determination module 1512 is adapted to perform the method of establishing a position of each UAV 206, as concurrently presented in FIG. 4A.

The UAV orientation parameter calculation module 1514 is adapted to calculate orientation parameters for each UAV according to the position of each UAV established by the UAV position determination module 1512 and according to the selected region of interest. According to one embodiment, the UAV orientation parameter calculation module 1514 is adapted to perform the method of determining orientation parameters for each UAV 208, as concurrently presented in FIG. 6A.

In some embodiments, upon obtaining the final orientation of the UAVs 106, it may be desirable to synchronize the rotation of the UAVs 106. Rotation may be used to leverage the determined positions and orientations of the UAVs 106. Synchronizing the rotation(s) may allow better coverage of the area of interest 104, reduce interference between UAVs 106, and/or reduce power consumption of the UAVs 106. The system 1500 may be provided with a UAV rotation synchronizer 1516 to perform one or more synchronization algorithms.

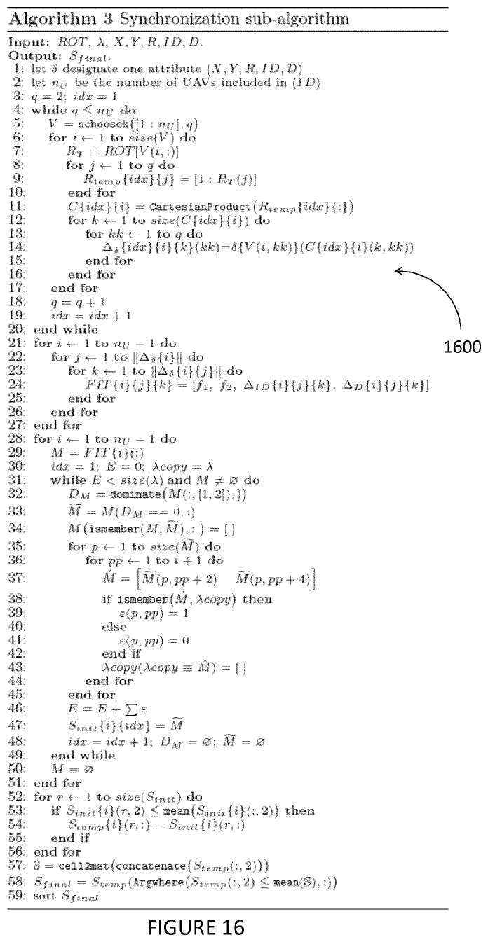

FIG. 16 illustrates an example synchronization algorithm 1600. In this example, the inputs are: X and Y (target Grid coordinates); R (the coverage radii); ID (to identify UAVs); D (the sub-map cardinal directions); λ (a two-column matrix whose rows list and map each UAV ID to one of its equivalent bearing directions; and ROT (a vector reckoning the total number of camera rotations per UAV).

Each possibility in the Cartesian product rows is taken as an index and the corresponding parameters (X, Y, R, ID, D), symbolized by Δ_{δ}, are extracted and used to evaluate all potential combinations. The Cartesian product is a functionality used to enumerate the ordered pairs obtained by combining all the elements in a binomially indexed array Rₜₑₙₚ, as shown in line 11 of the synchronization algorithm 1600. The number of binomial indices described by n_{U} items taken q at a time may be given by:

$$\frac{{n}_{U} !}{q ! ( {n}_{U} - q ) !} \qquad ( 18 )$$

where 2≤q≤n_{U} reflects the number of UAVs that should be rotated in each appointed combination.

Once all the combinations are identified, they may be accordingly and discretely evaluated via two objective functions ƒ₁ and ƒ₂ (equations 19a and 22). Function ƒ₁ may be used to compute the ratio of overlapping between the areas covered by the UAVs designed to be rotated (Δ_{ID}) and those that are excluded from being rotated (¬Δ_{ID}), and thus keeping their idle state and initial orientation. The ratio ƒ₁ may be determined in relation to the total area S:

$${f}_{1} = \frac{Obj\_Fun1 [ {Δ}_{ID} , ¬ {Δ}_{ID ]}}{s} \qquad ( 19 a )$$

$${Obj}_{F u n 1} = \{ \begin{matrix}θ & if 0 < d < 2 r \\ π . {r}^{2} & if d = 0 \\ 0 & otherwise\end{matrix} \qquad ( 19 b )$$

In this example, Obj_Fun1 is the overlap between the coverage zones of two UAVs, each enclosing a radius r and separated by a Euclidean distance d.

The function ƒ₂ may be used to compute the total ratio of non-coverage level by adding up the elements of \tilde{T} and then dividing by their complete number. \tilde{T} is given in equation 21 and is an updated version of T (equation 20), an m² sized vector filled with ones to express the magnitude of non-covered Grids inscribed in the m-by-m full Grid map, which are either farther than the coverage radii of Δ_{ID} UAVs or the horizontal field-of-view range of ¬Δ_{ID} UAVs.

$${T}_{i} = \{ \begin{matrix}{\sum }_{i = 1}^{{m}^{2}} {\sum }_{j = 1}^{‖ ¬ {Δ}_{ID} ‖} & \{ \begin{matrix}0 & if {d}_{i} \leq h . tan \frac{( {θ}_{H} )}{2} \\ 1 & otherwise\end{matrix} & if ‖ ¬ ID ‖ \neq 0 \\ 1 & & otherwise\end{matrix} \qquad ( 20 )$$

$${\tilde{T}}_{ι} = {\sum }_{i = 1}^{{m}^{2}} {\sum }_{j = 1}^{‖ {Δ}_{ID} ‖} \{ \begin{matrix} & 0 if {d}_{i} \leq {R}_{j} \\ {T}_{i} & otherwise\end{matrix} \qquad ( 21 )$$

$${f}_{2} = \frac{1}{{m}^{2}} {\sum }_{i = 1}^{{m}^{2}} {\tilde{T}}_{ι} \qquad ( 22 )$$

The fitness values may be allocated in an array named FIT and appended with the conforming UAV IDs and directions in order to be able to distinguish between each combination.

Referring back to the synchronization algorithm 1600, and depending on how many UAVs are to be rotated, all combinations that fulfill the prior requirement, i.e., referring to a same number of UAVs, may be joined together in one matrix M. A matrix \acute{M} may be built from the Pareto non-dominated rows of M. This Pareto dominance may be computed with respect to the remaining ƒ₁ and ƒ₂ values of M, since with every iteration the previously chosen non-dominated rows will be recursively removed from the original matrix M, and another two-column matrix \hat{M} is generated in the process. Matrix \hat{M} is similar to matrix λ as it contains UAV IDs and respective directions. To ensure that each UAV ID included in \hat{M} is allowed to rotate in a single direction only once, in some embodiments, a counter is constantly updated and that option is removed from the temporary copy of λ assigned for the current main loop.

A preliminary solution matrix Sᵢₙᵢₜ may be created to include the non-dominated options of \tilde{M} discovered thus far. Both M and \tilde{M} may be emptied at the end in order to re-launch the process by increasing the number of rotating UAVs. A temporary solution matrix Sₜₑₘₚ including all solutions that satisfy the condition raised in line 53 of the synchronization algorithm 1600 is used to make a final decision, i.e., the solutions that are deemed to be useful are those whose ƒ₂ scores are not worse than the average of all ƒ₂ values. Sₜₑₘₚ solutions do not belong to a unique class dependently on the number of rotating UAVs. These solutions are eventually teamed up together and those holding ƒ₂ scores inferior or equal to the average of all ƒ₂ values are accepted as ultimate solutions and enclosed in a terminating matrix S_{final}. The ultimate solutions may be sorted in ascending order of their ƒ₂ scores, placing on top the solution leading to the greater coverage level, and so forth.

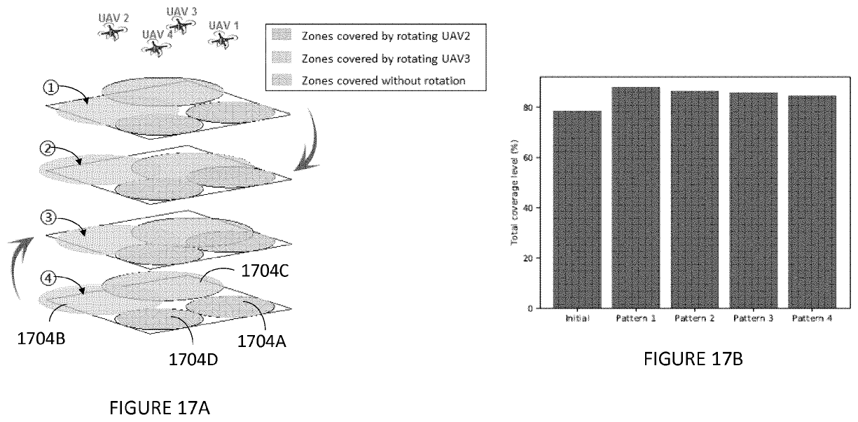

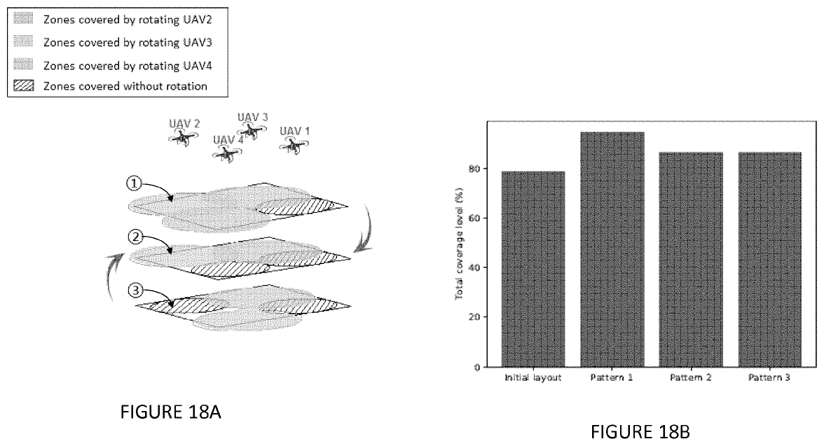

With reference to FIGS. 17A-17B, there is shown an example of UAV rotation. Four possible rotation patterns 1-4 are shown representing zone coverage of four UAVs. Each pattern has four zones, where zone 1704A is covered by UAV1, zone 1704B is covered by UAV2, zone 1704C is covered by UAV3, and zone 1704D is covered by UAV4. Two UAVs, namely UAV1 and UAV4, remain in an initial orientation while two UAVs, namely UAV2 and UAV3 rotate. Each possible rotation pattern represents a potential rotation scenario, as determined using the synchronization algorithm 1600. The resulting total coverage level is shown in FIG. 17B. FIGS. 18A-18B illustrate another example of UAV rotation. Pattern 1 results from rotating three UAVs, namely UA2, UAV3, and UAV4. Pattern 2 results from rotating only UAV2 and UAV3. Pattern 3 results from rotating only UAV2 and UAV4. As shown in FIG. 18B, pattern 1 provides the highest total coverage level, as compared to pattern 2, pattern 3, and the initial layout without rotation.

The present method 202 and system 1500 are adapted to use a simple and single population multi-objective genetic algorithm capable of optimizing two fitness terms while achieving a better performance. In addition, it is possible to apply a brute force algorithm, since only a reduced number of UAVs is needed to get a total coverage of an area. Moreover, the present method 202 and system 1500 are adapted to take into consideration any number of deployment criteria and are applicable to a variety of fields, while maintaining deployment accuracy irrespective of the number of criteria.

In addition, issues of on-demand coverage from ground terminals are met without the necessity to consider external factors (e.g., mobility of targets, density, distribution, etc.), since the targets are continuously covered with respect to a group of predetermined QoS requirements as deployment criteria. The present method 202 and system 1500 provide optimal hover coordinates of UAVs after efficiently setting a limit on their altitude in order to maximize the coverage lifetime and performance (i.e., better coverage with less energy consumption since the UAVs are less likely to leave their hover locations according to the novel hybrid heuristic).

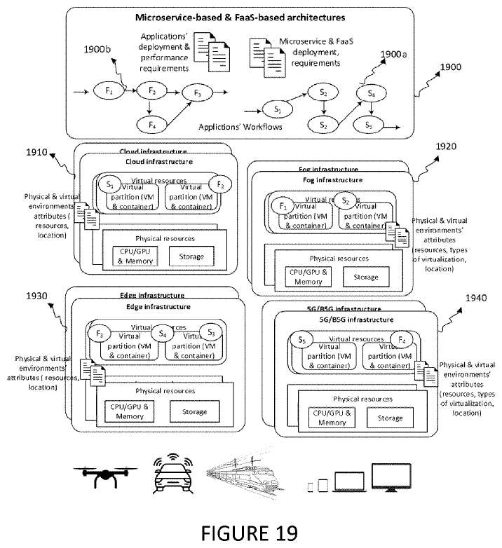

Referring now to FIG. 19, the evaluation method (reference 304 in FIG. 3A) or SAGA algorithm 900, described herein above with reference to FIGS. 3A, 3B, and 9A, may also be used for selecting a suitable set of microservices or FaaS configured to provide microservice-based or FaaS-based applications and deployed in distributed communication environments. In particular, the evaluation method 304 or SAGA algorithm 900 may be used to evaluate candidate options among a set of microservices or FaaS to be deployed in a distributed communication infrastructure by combining different sets of preference priorities and quantifiable objectives that can be considered when selecting a preliminary set of microservices or FaaS to be deployed.

FIG. 19 presents different deployment infrastructures of microservices-based or FaaS-based applications, according to one embodiment. Each infrastructure offers physical and virtual resources with different attributes (e.g., types of resource, virtualization technologies, scalability) and each application's workflow has different deployment and performance requirements (e.g., latency, availability, security) and is composed of a set of microservices or FaaS each having different deployment requirements (e.g., libraries/dependencies, runtime, resource needs). As can be seen from FIG. 19, the microservices or FaaS may be deployed, for example, across a distributed IoT, Cloud, Fog, Edge and 5G/B5G communication infrastructure to provide smart city applications. FIG. 19 presents microservice-based or FaaS-based applications 1900 and a communication infrastructure including cloud infrastructure 1910, fog infrastructure 1920, edge infrastructure 1930, and 5G/B5G infrastructure 1940 providing virtual resources to host the applications. The infrastructures 1910, 1920, 1930, 1940 have various physical and virtual environments' attributes (e.g., type and amount of resources, type of virtualization, location) that are configurable according to the application's needs (e.g., performance, deployment). For instance, the application workflow 1900a has five (5) chained microservices (labelled S1, S2, S3, S4, and S5 in FIG. 19) and the application workflow 1900b has four (4) chained FaaS (labelled F1, F2, F3 and F4 in FIG. 19).

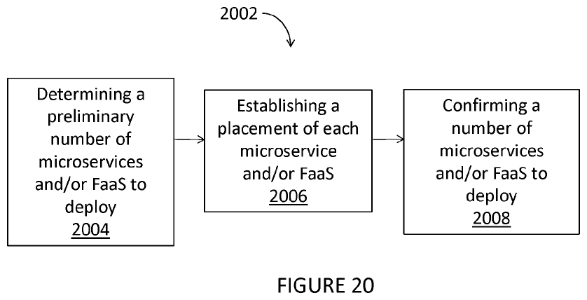

According to one embodiment, as presented in FIG. 20, a method 2002 of planning microservices and/or FaaS deployment includes determining a preliminary number of microservices and/or FaaS to be deployed 2004, establishing a placement of each microservices and/or FaaS 2006, and confirming the number of microservices and/or FaaS to deploy 2008.

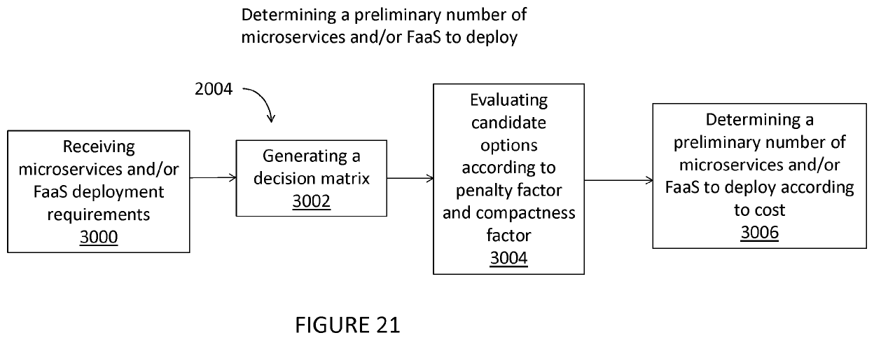

Referring to FIG. 21, the determining a preliminary set of microservices and/or FaaS to be deployed includes receiving at 3000 the microservices and/or FaaS deployment requirements, generating a decision matrix at 3002, evaluating candidate options according to a penalty factor and a compactness factor at 3004, and determining a preliminary number of microservices and/or FaaS to deploy according to cost at 3006. The deployment requirements received at 3000 are application specific (e.g., distributed/hybrid microservice-based or FaaS-based applications, reliability and security needs), microservice or FaaS specific (e.g., libraries/dependencies, runtime, resource needs) and also specific to the deployment environment (e.g., resource constrained, type of virtualization technologies, geographical location). According to the received deployment requirements, the decision matrix is generated at 3002 in order to determine an appropriate preliminary set of microservices and/or FaaS that are to be deployed and to satisfy (i.e., minimize) a targeted deployment cost (e.g., resource & energy consumption costs, performance violation costs). For example, the microservices (reference 1900a in FIG. 19) may be deployed in virtual partitions (e.g., container) hosted in Cloud, Fog, Edge and/or 5G/B5G infrastructure.

The evaluating candidate options according to a penalty factor and compactness factor at 3004 may be performed for microservices or FaaS in a manner similar to that described herein above with reference to FIG. 3B. Similarly, the establishing a placement of each microservice or FaaS at 2006 may be performed in a manner similar to that described herein above with reference to FIGS. 4A and 4B.

The embodiments described in this document provide non-limiting examples of possible implementations of the present technology. Upon review of the present disclosure, a person of ordinary skill in the art will recognize that changes may be made to the embodiments described herein without departing from the scope of the present technology.

1. A method for selecting and deploying one of a set of unmanned aerial vehicles (UAVs) over a geographical area of interest and a set of microservices or Functions-as-a-Service (FaaS) over a distributed communication environment, the method comprising:
selecting a preliminary number of UAVs, microservices or FaaS for deployment by:
defining possible outcomes for a plurality of criteria having predefined constraints and associated priority weights;
computing a penalty factor score (SPF) based on whether or not each one of the possible outcomes violates the predefined constraints;
computing a compactness factor score (SCF) based on how close or far the possible outcomes are from an average score of all values falling under a same type of criteria;
determining a ranking of the possible outcomes using SPF and SCF; and
selecting the preliminary number of UAVs, microservices or FaaS based on the ranking; and one of:
determining positions of the preliminary number of UAVs within the area of interest to maximize coverage of the area of interest and minimize overlap between the preliminary number of UAVs, and determining orientations of the preliminary number of UAVs within the area of interest for the positions as determined; and
determining a placement of the preliminary number of microservices or FaaS over the distributed communication environment to minimize a targeted deployment cost.

2. The method of claim 1, further comprising reassessing the preliminary number of UAVs for deployment as a function of the positions and orientations as determined or reassessing the preliminary number of microservices or FaaS for deployment as a function of the placement as determined.

3. The method of claim 1, further comprising synchronizing a rotation of the UAVs based on the positions and orientations of the preliminary number of UAVs.

4. The method of claim 1, wherein selecting the preliminary number of UAVs, microservices or FaaS further comprises computing a distance factor score (SDF) by measuring a distance between the possible outcomes for the plurality of criteria and the corresponding constraints for the criteria; and wherein ranking the possible outcomes comprises ranking using SPF, SCF and SDF.

5. The method of claim 1, wherein the geographical area of interest is modeled as one of circular, rectangular, triangular, and square shaped areas.

6. The method of claim 1, wherein the geographical area of interest is divided into sub-areas.

7. The method claim 1, wherein the predefined constraints are defined using linguistic quantifiers and logic operators.

8. The method of claim 7, wherein textual terms are converted into the linguistic quantifiers using machine learning.

9. The method of claim 1, wherein a parameter is used to differentiate between beneficial criteria and cost criteria, where the parameter is 1 for the beneficial criteria and 0 for the cost criteria, and wherein the possible outcomes that violate the predefined constraints are retained for the ranking.

10. The method of claim 1, further comprising deploying the UAVs with the positions and orientations as determined or deploying the microservices or FaaS with the placement as determined.

11. A system for selecting and deploying one of a set of unmanned aerial vehicles (UAVs) over a geographical area of interest and a set of microservices or Functions-as-a-Service (FaaS) over a distributed communication environment, the system comprising:
a processor; and
a non-transitory computer readable medium having stored thereon program instructions executable by the processor for:
selecting a preliminary number of UAVs, microservices or FaaS for deployment by:
defining possible outcomes for a plurality of criteria having predefined constraints and associated priority weights;
computing a penalty factor score (SPF) based on whether or not each one of the possible outcomes violates the predefined constraints;
computing a compactness factor score (SCF) based on how close or far the possible outcomes are from an average score of all values falling under a same type of criteria;
determining a ranking of the possible outcomes using SPF and SCF; and
selecting the preliminary number of UAVs, microservices or FaaS based on the ranking; and
one of:
determining positions of the preliminary number of UAVs within the area of interest to maximize coverage of the area of interest and minimize overlap between the preliminary number of UAVs, and determining orientations of the preliminary number of UAVs within the area of interest for the positions as determined; and
determining a placement of the preliminary number of microservices or FaaS over the distributed communication environment to minimize a targeted deployment cost.

12. The system of claim 11, wherein the program instructions are further executable for reassessing the preliminary number of UAVs for deployment as a function of the positions and orientations as determined or reassessing the preliminary number of microservices or FaaS for deployment as a function of the placement as determined.

13. The system of claim 11, wherein the program instructions are further executable for synchronizing a rotation of the UAVs based on the positions and orientations of the preliminary number of UAVs.

14. The system of claim 11, wherein selecting the preliminary number of UAVs, microservices or FaaS further comprises computing a distance factor score (SDF) by measuring a distance between the possible outcomes for the plurality of criteria and the corresponding constraints for the criteria; and wherein ranking the possible outcomes comprises ranking using SPF, SCF and SDF.

15. The system of claim 11, wherein the geographical area of interest is modeled as one of circular, rectangular, triangular, and square shaped areas.

16. The system of claim 11, wherein the geographical area of interest is divided into sub-areas.

17. The system of claim 11, wherein the predefined constraints are defined using linguistic quantifiers and logic operators.

18. The system of claim 17, wherein textual terms are converted into the linguistic quantifiers using machine learning.

19. The system of claim 11, wherein a parameter is used to differentiate between beneficial criteria and cost criteria, where the parameter is 1 for the beneficial criteria and 0 for the cost criteria, and wherein the possible outcomes that violate the predefined constraints are retained for the ranking.

20. The system of claim 11, wherein the program instructions are further executable for deploying the UAVs with the positions and orientations as determined or deploying the microservices or FaaS wih the placement as determined.
